(19) United States
(12) Patent Application Publication
(10) Pub. No.: US 2023/0316404 A1
(43) Pub. Date: Oct. 5, 2023

(54) AUTOMATED MOVE MONEY AUTHORIZATION GENERATION

(71) Applicant: Altruist Corp., Venice, CA (US)

(72) Inventors: Rachel BROWN, Santa Monica, CA (US); Mazi BAHADORI, Irvine, CA (US); Blake HUNTER, Los Angeles, CA (US); Igor TSELUIKO, Marina Del Rey, CA (US); Dmytro LYTVYNENKO, Irvine, CA (US)

(21) Appl. No.: 18/188,673

(22) Filed: Mar. 23, 2023

Related U.S. Application Data
(60) Provisional application No. 63/362,503, filed on Apr. 5, 2022.

(51) Int. Cl. G06Q 40/06; G06Q 20/40

(52) U.S. Cl. CPC G06Q 40/06; G06Q 20/4014

(57) ABSTRACT

Techniques and systems for automatically generating an authorization for moving funds on behalf of a client are described. An example technique includes detecting a first request to create a transfer authorization for a first client account. An indication of a type of transfer option associated with the first client account is presented. A set of second client accounts that are linked to the first client account within the application and that support the type of transfer option are determined. A selection state of the second client account indicating whether the second client account is selected is determined for each second client account. An electronic transfer authorization form is automatically generated based on the second selection state of each second client account. A second request is transmitted to one or more users associated with the selected set of second client accounts to approve the electronic transfer authorization form.

### CROSS-REFERENCE TO RELATED APPLICATION

This application claims benefit of co-pending U.S. Provisional Patent Application Ser. No. 63/362,503 filed Apr. 5, 2022. The aforementioned related patent application is herein incorporated by reference in its entirety for all purposes.

### BACKGROUND

Registered investment advisers provide clients with a variety of financial services in order to help clients with their financial goals. For example, these financial services can include investment management, budgeting guidance, etc. Many of these financial services involve moving (or transferring) money (or funds) between a client's accounts. For example, a registered investment advisor can withdraw money from the client's savings account and deposit the money into the client's brokerage account, or vice versa.

Registered investment advisers generally rely on permissions (or authorizations) within a standing letter of authorization (LOA) in order to move money on behalf of a client. For example, a standing LOA is a legal agreement between the client and registered investment advisor that authorizes the registered investment advisor to perform certain functions or powers on behalf of the client. The process of moving money without a standing LOA in place can be significantly complex and time-consuming. For example, without a standing LOA in place, the client would generally have to manually fill out paperwork each time the registered investment advisor wanted to transfer funds.

### SUMMARY

Certain embodiments described herein include a computer-readable storage medium. The computer-readable storage medium stores instructions, which, when executed on one or more computing systems, performs an operation. The operation includes detecting, on a page of an application, a first request to create a transfer authorization for a first client account. The operation also includes, in response to the first request, presenting, on the page of the application, an indication of a type of transfer option associated with the first client account. The operation also includes, upon determining that a first selection state of the type of transfer option indicates the type of transfer option is selected, determining a set of second client accounts that are linked to the first client account within the application and that support the type of transfer option. The operation also includes determining, for each of the set of second client accounts, a second selection state of the second client account indicating whether the second client account is selected. The operation also includes automatically generating an electronic transfer authorization form, based on the second selection state of each of the set of second client accounts. Automatically generating the electronic transfer authorization form includes auto-populating the electronic transfer authorization form with information authorizing transfers between the first client account and the selected set of second client accounts. The operation further includes transmitting a second request to one or more users associated with the selected set of second client accounts to approve the electronic transfer authorization form.

Certain embodiments described herein include a computer-implemented method. The computer-implemented method includes detecting, on a page of an application, a first request to create a transfer authorization for a first client account. The computer-implemented method also includes, in response to the first request, presenting, on the page of the application, an indication of a type of transfer option associated with the first client account. The computer-implemented method also includes upon determining that a first selection state of the type of transfer option indicates the type of transfer option is selected, determining a set of second client accounts that are linked to the first client account within the application and that support the type of transfer option. The computer-implemented method also includes determining, for each of the set of second client accounts, a second selection state of the second client account indicating whether the second client account is selected. The computer-implemented method also includes automatically generating an electronic transfer authorization form, based on the second selection state of each of the set of second client accounts. Automatically generating the electronic transfer authorization form includes auto-populating the electronic transfer authorization form with information authorizing transfers between the first client account and the selected set of second client accounts. The computer-implemented method further includes transmitting a second request to one or more users associated with the selected set of second client accounts to approve the electronic transfer authorization form.

Certain embodiments described herein include a system. The system includes one or more processors and a memory. The memory includes instructions, which when executed by the one or more processors causes the system to perform an operation. The operation includes detecting, on a page of an application, a first request to create a transfer authorization for a first client account. The operation also includes, in response to the first request, presenting, on the page of the application, an indication of a type of transfer option associated with the first client account. The operation also includes upon determining that a first selection state of the type of transfer option indicates the type of transfer option is selected, determining a set of second client accounts that are linked to the first client account within the application and that support the type of transfer option. The operation also includes determining, for each of the set of second client accounts, a second selection state of the second client account indicating whether the second client account is selected. The operation also includes automatically generating an electronic transfer authorization form, based on the second selection state of each of the set of second client accounts. Automatically generating the electronic transfer authorization form includes auto-populating the electronic transfer authorization form with information authorizing transfers between the first client account and the selected set of second client accounts. The operation further includes transmitting a second request to one or more users associated with the selected set of second client accounts to approve the electronic transfer authorization form.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a block diagram illustrating an example system for generating a digital LOA, according to certain embodiments.

FIG. 2 further illustrates certain components of the system illustrated in FIG. 1 in more detail, according to certain embodiments.

FIG. 3 is a flowchart of an example method for generating a digital LOA, according to certain embodiments.

FIG. 4 is a flowchart of an example method for generating a response to a request to approve a digital LOA, according to certain embodiments.

FIG. 5 is a flowchart of an example method for initiating an account transfer based on an authorization, according to certain embodiments.

FIG. 6 is a flowchart of an example method for modifying an authorization, according to certain embodiments.

FIGS. 7A-7L depict an example sequence of a user interaction with an application to generate a digital LOA, according to certain embodiments.

FIGS. 8A-8K depict another example sequence of a user interaction with an application to generate a digital LOA, according to certain embodiments.

FIGS. 9A-9M depict an example sequence of a user interaction with an application to respond to a request to approve a digital LOA, according to certain embodiments.

FIGS. 10A-10E depict an example sequence of a user interaction with an application to initiate an account transfer, according to certain embodiments.

FIGS. 11A-11B depict an example sequence of a user interaction with an application to view an account transfer, according to certain embodiments.

FIGS. 12A-12G depict an example sequence of a user interaction with an application to modify a digital LOA, according to certain embodiments.

FIGS. 13A-13C depict an example sequence of a user interaction with an application to revoke a digital LOA, according to certain embodiments.

FIG. 14 illustrates an example computing system, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments herein describe systems and techniques for generating an authorization for moving funds (or money) (also referred to herein as a move money authorization (MMA)) on behalf of a client. In certain embodiments described herein, a computing environment (or platform), such as a cloud computing environment, provides software applications and/or computing services that enable registered investment advisors (also referred to herein as financial advisors) to interact with clients in order to provide financial services to the clients. The example cloud computing environment may allow users (e.g., registered investment advisors, clients, auditing personnel, etc.) access to both online services and local client applications, regardless of whether the application is installed locally by a user or accessed as an online service (e.g., via an e-commerce/brokerage website). Once client data is stored by the cloud computing environment, users can access data using a variety of clients, including a web browser used to access a software application as a series of web pages, dedicated “thin” client applications, and so-called “apps” accessed using a mobile telephone or computing tablet.

As part of the computing services, the example cloud computing environment may allow registered investment advisors to set up different types of brokerage accounts (e.g., individual accounts, trust accounts, joint accounts, individual retirement account (IRA), Roth IRAs, simplified employee pension plan (SEP) IRAs, etc.), connect bank accounts to brokerage accounts, build custom model portfolios, trade shares, trade fractional shares, generate and share performance reports, and perform other types of transactions. The cloud computing environment may also enable registered investment advisors to initiate account transfers between a client's accounts in order to move funds as part of managing the client's finances. Generally, a client has to grant authorization to a registered investment advisor before the registered investment advisor can initiate an account transfer on behalf of the client. This authorization is typically in the form of a LOA, which, for example, may indicate the bank accounts that the registered investment advisor is authorized to access, the type of transfers for the brokerage accounts that the registered investment advisor is allowed to initiate, the type of transfers for the bank accounts that the registered investment advisor is allowed to initiate, etc.

In conventional systems that provide financial services, the process of obtaining a LOA can involve the client having to manually fill out and sign appropriate paperwork (e.g., paper forms) for the relevant bank accounts. However, obtaining a LOA in this manner can be significantly complex and time consuming (e.g., lasting up to several days in some instances). For example, the registered investment advisor may have to send a link or request to the client and the client may have to access the link (which involves calling the server, etc.) to download and print the paper form. The client may then have to manually fill out the paper form and upload the form to the registered investment advisor.

In contrast, certain embodiments described herein can generate a digital authorization for moving funds in near real-time, upon receiving a request from a user (e.g., registered investment advisor) interacting with the cloud computing environment. The digital authorization may be in the form of (or include) a digital LOA. Certain embodiments described herein can send requests to the associated user(s) (e.g., account owner(s)) to approve the digital LOA. If the associated user(s) approve the digital LOA, then the cloud computing environment can generate a standing LOA (e.g., active LOA) authorizing the registered investment advisor to initiate account transfers in accordance with the permissions indicated in the LOA. In this manner, certain embodiments described herein enable a registered investment advisor to gain access to move funds on the authorized accounts within seconds of the approval. For example, additional pings to the server to fill out the LOA online can be skipped by configuring the system to auto-populate the LOA. In this manner, both clients and registered investment advisors are enabled to set up (i) one-time, scheduled, and recurring automated clearing house (ACH) transfers between the clients' brokerage account(s) and bank account(s), (ii) one-time, scheduled, and recurring internal transfers (also referred to as cash journals) between the client's brokerage accounts, (iii) one-time, scheduled, and recurring wire transfers between the clients' brokerage account(s) and bank account(s), (iv) one-time, scheduled, and recurring check distributions (e.g., to initiate or request that a physical check be sent to the client or a third party), and/or (v) a full account transfer of the client's account at one brokerage firm to another brokerage firm. Additionally, certain embodiments enable registered investment advisors to request updates to the standing LOA and/or enable both clients and registered investment advisors to revoke the standing LOA at any time.

Note that many of the following embodiments use ACH transfers as a reference example of a type of transaction that can be authorized within a digital LOA using the systems and techniques described herein. However, the embodiments described herein can be used for a variety of different types of transactions, including, for example, internal transfers, wire transfers, check distributions, full account transfers, etc. As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12.”

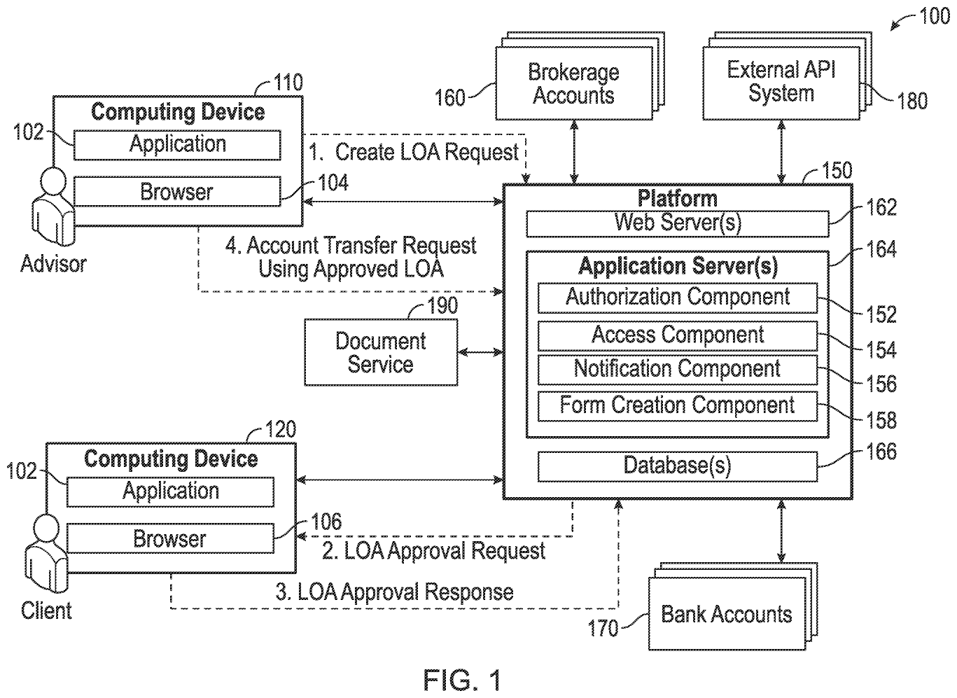

FIG. 1 is a block diagram illustrating an example system 100 for generating a digital LOA, according to certain embodiments. Generally, FIG. 1 and the following description are intended to provide a brief, general description of a suitable computing environment in which the embodiments described herein may be implemented. As shown, FIG. 1 includes a platform 150 (also referred to herein as a cloud computing platform, computing platform, or cloud computing environment), a computing device 110, a computing device 120, external application programming interface (API) systems 180, a document service 190, brokerage accounts 160, and bank accounts 170. Note that while a single computing device 110 and a single computing device 120 are depicted, in certain embodiments, the system 100 may include any number of computing devices 110 and any number of computing devices 120.

The platform 150 may include a number of application servers 164 that provide various online web and application services to the computing devices 110 and 120 over a network. A user (e.g., registered investment advisor) may use the computing device 110 to interact with the platform 150. Similarly, a user (e.g., client) may use the computing device 120 to interact with the platform 150. Computing devices 110 and 120 are representative of a variety of computing devices, including, for example, a personal computer, a desktop workstation, a laptop, a tablet computer, a notebook, a personal digital assistant (PDA), an electronic book reader, a game console, smart television, a set-top box, a consumer electronics device, a server computer, or any other computing device capable of communicating with the platform 150 across a network (e.g., local area network (LAN), wireless LAN, personal area network (PAN), a cellular network, wide area network (WAN), Internet, combinations thereof, etc.).

The computing devices 110 and 120 are generally configured to host applications used to access and utilize the web and application services provided by the platform 150. For example, computing device 110 includes an application 102-1 and/or a (web) browser 104. Similarly, computing device 120 includes an application 102-2 and/or a browser 106. The browsers 104, 106 can be used to access the platform 150 by rendering web pages received from the platform 150. The application 102 is representative of a component of a client server application (or other distributed application) which can communicate with the platform 150 over a network. Application 102 may be a “thin” client where the processing is largely directed by the application 102, but performed by computing systems of the platform 150 or may be a conventional software application installed on the computing devices 110 and 120.

The application 102 and/or browsers 104 and 106 are configured to communicate with the platform 150. In certain embodiments, the application 102 and/or browsers 104 and 106 can exchange data with application server(s) in the platform 150 using the hypertext transfer protocol (“HTTP”) over a network. In general, the application 102 and/or browsers 104 and 106 can utilize any number of communication methods known in the art to communicate with the application server(s) in the platform 150, including remote procedure calls, API calls, Simple Object Access Protocol (SOAP)-based web services, remote file access, proprietary client-server architectures, and the like.

In the case where the platform 150 provides financial management services, the application 102 and/or browsers 104 and 106 may provide software which allows a user (e.g., registered investment advisor) to manage one or more brokerage accounts on behalf of another user (e.g., client). The platform 150 may also provide other features, such as the ability to set up different types of brokerage accounts, connect bank accounts to the brokerage accounts, build custom model portfolios, trade shares, trade fractional shares, generate and share performance reports, etc. In certain embodiments described in more detail below, the platform 150 may also provide the ability to generate, update, and/or revoke a digital LOA authorizing a user (e.g., registered investment advisor) to move client funds.

As shown, the platform 150 includes a web server(s) 162, an application server(s) 164, and a database(s) 166. In the depicted embodiment, the platform 150 is modeled as a service back-end (e.g., web server(s), application server(s), database(s), etc.). Of course, other software architectures or distributed application frameworks could be used. The web server(s) 162 and application server(s) 164 may be representative of physical computing systems, as well as representative of virtual machine instances deployed to a computing cloud environment. Similarly, the database(s) 166 can be located on a single computing system or distributed across multiple computing systems. The web server(s) 162 may communicate with the application server(s) 164 to respond to requests from applications (e.g., application 102) and/or browsers (e.g., browsers 104, 106) on the computing devices 110 and 120. The web server(s) 162 and/or application server(s) 164 may retrieve application content from the database(s) 166 to respond to requests from the applications and/or browsers on the computing devices 110 and 120, and/or store application content into the database(s) 166.

The application server(s) 164 may execute a number of components (also referred to as modules) to provide web-based and other content to the computing devices 110 and 120. The components may execute on a single application server 164 or in parallel across multiple application servers in the platform 150. In addition, each component may consist of a number of subcomponents executing on different application servers 164 or other computing devices in the platform 150. The components may be implemented as software, hardware, or any combination thereof. In certain embodiments, the application server(s) 164 include an authorization component 152, an access component 154, a notification component 156, and a form creation component 158, each of which is described in more detail below.

In certain embodiments, the application server(s) 164 include application content (e.g., graphical user interface (GUI) components) that platform 150 can present on computing devices 110, 120, based on a user's (e.g., registered investment advisor, client, etc.) interaction with the platform 150. The application content can include, for example, HyperText Markup Language (HTML) components or code that generates HTML components that can be passed to computing devices 110, 120 and rendered as a user interface. The application content may additionally include instructions executable by computing devices 110, 120 to display a user interface using language-specific or operating systems-specific application content (e.g., instructions for generating/displaying javascript based components or similar components on other operating system platforms, Abstract Window Toolkit or Swing API components on the Java platform, and so on). Generally, instructions capable of rendering application content on computing devices 110, 120 may include computer executable code generated from compiling and/or interpreting C (or variants thereof), Java, PHP, Ruby, HTML, javascript, Python, AJAX, VBscript, and other programming or scripting languages used to compose and present application content.

The brokerage accounts 160 are representative of different types of brokerage accounts, including, for example, individual accounts, trust accounts, joint accounts, IRAs, Roth IRAs, SEP IRAs, etc. The bank accounts 170 can include individual accounts, joint accounts, etc. The document service 190 is generally representative of a document management system (DMS). For example, the document service 190 can receive, track, manage, and store documents (including LOA forms). In certain embodiments, the document service 190 can keep track of different versions of digital forms that have been generated and modified by different users over time. The document service 190 may be implemented on one or more computing systems, which may be located within a cloud environment.

In certain embodiments, information associated with the brokerage accounts 160, bank accounts 170, and/or document service 190 may be located on computing systems external to the platform 150. For example, such external computing systems may include applications and/or databases that host this information. In such embodiments, the external API system(s) 180 generally allow the platform 150 to interact with these external computing systems. For example, the external API system(s) 180 can provide a data transfer network/infrastructure that allows applications provided by the platform 150 to access applications and/or databases within the external computing systems with a set of custom APIs. As a reference example, assuming information associated with a client's bank account is located on an external computing system, the platform 150 can use the external API system to connect to the external computing system (e.g., hosting information associated with the client's bank account 170) in order to initiate an account transfer (e.g., withdrawal, deposit, etc.), check a balance, make a payment, etc. Examples of external API system(s) 180 include, but are not limited to, Plaid®, Stripe Connect®, MX®, Codat®, Yodlee®, etc.

Note that while the brokerage accounts 160, bank accounts 170, and/or document service 190 are shown external to the platform 150, in certain embodiments, the information associated with brokerage accounts 160, bank accounts 170, and/or document service 190 may be located on one or more computing system(s) within the platform 150. For example, information associated with one or more of the brokerage accounts 160 and/or one or more of the bank account(s) 170 may be hosted (or maintained) within one of the database(s) 166.

The authorization component 152 is generally configured to generate a digital LOA containing permissions that authorize a registered investment advisor to move funds on behalf of a client. The authorization component 152 may receive a request from the computing device 110 (associated with the registered investment advisor) that requests the authorization component 152 to generate the digital LOA. In certain embodiments, the request is in the form of an API call. The API call may include parameters indicating at least one of: an indication of the brokerage account(s) associated with the digital LOA, a type of the brokerage account(s), an indication of the bank account(s) associated with the digital LOA, a type of the bank account(s), a type of transfer to authorize for the bank account(s), an indication of the bank account owners (or account holders), etc.

In certain embodiments, in response to receiving the request, the authorization component 152 can use an external API system(s) 180 to connect with (or access) the indicated bank account(s) 170 and retrieve information (e.g., account number(s), routing number(s), account holder information, etc.) associated with the indicated bank account(s). Note, however, that in certain embodiments, the authorization component 152 may retrieve the information from another storage system (e.g., database(s) 166).

The authorization component 152 can obtain a digital LOA form (e.g., from database(s) 166) and trigger the form creation component 158 to auto-populate the digital LOA with the applicable information obtained from at least one of the request from the computing system 110, the bank account(s) 170, the database(s) 166, etc. For example, the digital LOA form may include one or more blank fields for account number, bank name, routing number, account holder name, etc. The form creation component 158 can execute an automated script to read data from the digital LOA, detect the form fields, and input data in order to fill out the form fields.

The notification component 156 is generally configured to communicate with computing devices 110, 120 and other computing systems in the network. For example, as described below, the notification component 156 can send requests to approve a digital LOA to one or more computing devices 120 associated with clients that are account holder(s) of the bank account(s) within the LOA. Similarly, the notification component 156 can generate and transmit alerts to relevant computing devices in response to various events, including, for example, revocation of standing LOAs, denial of pending LOAs, acceptance of pending LOAs, LOA renewal requests, initiated account transfer, completed account transfer, etc.

The access component 154 is generally configured to interact with bank account(s) 170 and/or brokerage account(s) 160, based on the permissions within a standing LOA. For example, in response to a request from a computing device 110 to initiate an account transfer using a standing LOA, the access component 154 can connect to the relevant bank account 170 via the external API system(s) 180 to execute the account transfer (e.g., withdrawal, deposit, etc.). In another example, the access component 154 can initiate internal transfers between brokerage accounts 160 associated with a client, using a standing LOA. In yet another example, the access component 154 can connect to a bank account 170 via an external API system(s) 180 to initiate a wire transfer.

In the embodiment depicted in FIG. 1, the platform 150 receives a “Create LOA Request” from the computing device 110 (associated with a registered investment advisor). In certain embodiments, the registered investment advisor may use the computing device 110 (e.g., application 102 and/or browser 104) to indicate one or more of the following as part of the “Create LOA Request”: the brokerage account(s) 160, bank account(s) 170, type of transfer, etc. In response to the request, the platform 150 can retrieve the applicable information to include within digital LOA form and digitally populate one or more fields of the digital LOA form based on the information.

In certain embodiments, the “Create LOA Request” may indicate the brokerage account(s) 160 (e.g., without indicating the bank account(s) 170). In such embodiments, the platform 150 may determine whether the brokerage account(s) 160 is linked to a bank account(s) 170 and may use the external API system(s) 180 to connect to the bank account(s) 170 and retrieve information from the bank account(s) 170 for populating the fields of the digital LOA.

The platform 150 can generate and transmit a “LOA Approval Request” to the computing device 120. The “LOA Approval Request” requests the user (e.g., client) of the computing device 120 to approve the digital LOA form generated by the platform. In response to the “LOA Approval Request,” the computing device 120 may transmit a “LOA Approval Response” to the platform 150. The “LOA Approval Response” may indicate whether the user (e.g., client) approves or declines the digital LOA form. In certain embodiments where the “LOA Approval Response” indicates that the digital LOA form is declined, then the platform 150 may transmit an indication that the digital LOA has been declined to the computing device 110. In certain embodiments where the “LOA Approval Response” indicates an approval of the digital LOA form, then the platform 150 may change a status of digital LOA form (e.g., from pending to active (or standing)) and may transmit an indication that the digital LOA has been approved to the computing device 110 (e.g., assuming all applicable account owners have approved the digital LOA).

Once there is a standing LOA in place for a given client, the registered investment advisor can use the computing device 110 to initiate an account transfer to move funds associated with the client's brokerage account. For example, the registered investment advisor can initiate an ACH transfer between a brokerage account and a bank account, an internal transfer between brokerage accounts, a wire transfer between a brokerage account and bank account, etc.

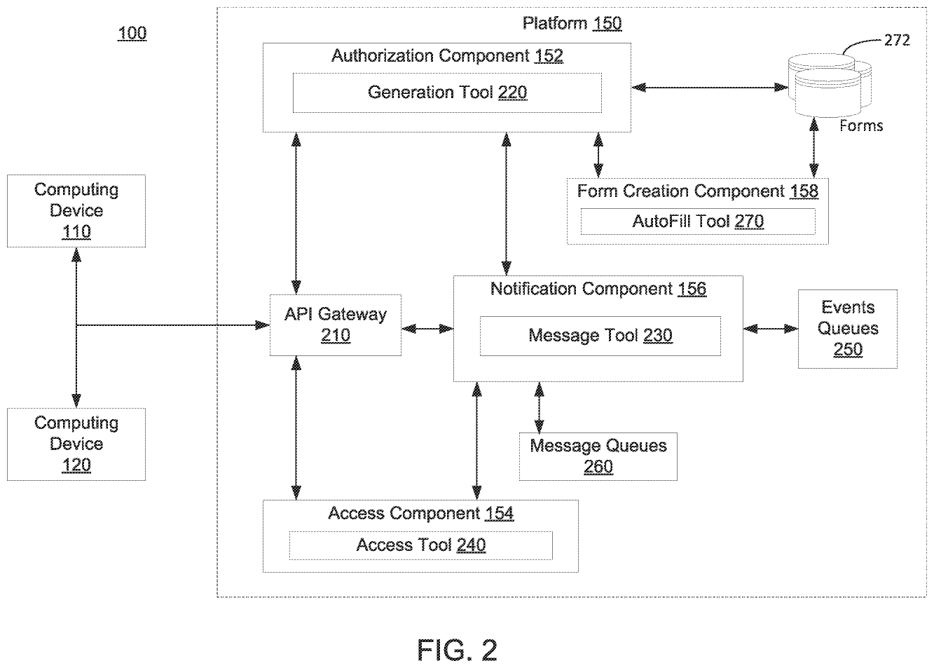

FIG. 2 further illustrates components of the system 100, described relative to FIG. 1, according to certain embodiments. As noted, the platform 150 is generally responsible for implementing the back-end processes that enable a user (e.g., registered investment advisor, client, etc.) to access the computing services provided by the platform 150, via applications (e.g., application 102) and/or browsers (e.g., browsers 104, 106). In certain embodiments, the platform 150 can be based on a micro-services architecture. In certain embodiments, the platform 150 is implemented using one or more cloud computing services.

As shown in FIG. 2, the platform 150 includes an API Gateway 210, event queues 250, message queues 260, and databases 272. Note that the number of components depicted in FIG. 2 is a reference example and that the platform 150 can include any number of components (e.g., API Gateways, message queues, event queues, etc.). The API Gateway 210 receives and forwards requests from the applications 102-1 and 102-2 and/or browsers 104, 106 of the computing devices 110 and 120. Additionally, the API Gateway 210 may receive and forward responses from one or more components (e.g., authorization component 152, form creation component 158, notification component 156, access component 154, etc.) to the application and/or browsers of the computing devices 110 and 120.

In certain embodiments, the API Gateway 210 employs a request/response model. In such embodiments, API requests may be sent to the API Gateway 210 using Representational State Transfer (REST) API methods. For example, the API requests can include API methods, such as GET, POST, PUT, etc. In certain embodiments, the API Gateway 210 employs a bi-directional, full-duplex communication model. In such embodiments, the API Gateway 210 can use websocket APIs to allow computing devices and components to send messages independently. That is, the communication may not require a new connection to be set up for each message sent between clients and services. Once the connection is set up, messages can be sent and received continuously without interruption.

As shown, the authorization component 152 includes a generation tool 220, which is generally configured to generate a digital LOA form. The generation tool 220 may obtain (or retrieve) the applicable LOA form from the database(s) 272, which can store different types of LOA forms. The different types of LOA forms may be associated with at least one of different geographical jurisdictions (e.g., different states may have different legal standards for LOA forms), different types of transfers (e.g., ACH transfers, wire transfers, etc.), different types of brokerage accounts, etc. In certain embodiments, upon receiving an API request to generate a digital LOA from the computing device 110 via the API gateway 210, the generation tool 220 can determine the type of LOA form to retrieve from the database(s) 272, based one or more attributes of the API request. These attributes can include, but are not limited to, brokerage account identifier, bank account identifier, type of brokerage account, type of bank account, type of transfer, number of account holders, etc.

The generation tool 220 can trigger the form creation component 158 to auto populate one or more fields of the digital LOA form retrieved from the database(s) 272. In certain embodiments, the form creation component 158 includes an autofill tool 270, which can detect form fields in the digital LOA, and populate the form fields with information obtained from the API request and/or storage systems (e.g., database(s) 272, external API systems 180, bank accounts 170, brokerage accounts 160, etc.).

Each form field may include a token (or keyword) (in ASCII format, for example) that indicates the type of information that belongs in the form field. For example, a digital LOA form may have a first form field with “advisor_name,” a second form field with “bank_account1_name,” a third form field with “bank_account1_number,” a fourth form field with “bank_account1_accountholder,” a fifth form field with “bank_account2_name,” a sixth form field with “bank_account2_number,” a seventh form field with “bank_account2_accountholder,” and so on. The autofill tool 270 can determine the type of data and data format for each form field in the digital LOA form from the token (or keyword) in the form field. The autofill tool 270 can then modify each of the form fields with the corresponding data. In certain embodiments, the data for the form field may be extracted from the API request and/or storage systems. The autofill tool 270 can save the filled digital LOA form in one or more different file formats, including, for example, portable document format (PDF), .doc, HTML, etc., and store the filled digital LOA in a storage system (e.g., database(s) 166, document service 190, etc.).

As shown, the access component 154 includes an access tool 240, which can interact with external bank accounts (e.g., bank accounts 170) to perform account transfers (e.g., deposits, withdrawals, etc.). The access component 154 can send API calls to external API systems 180 in order to connect to and access the external systems (e.g., bank accounts) to perform the account transfer.

As shown, the notification component 156 includes a message tool 230, which is generally configured to handle messages between the platform 150 and the computing devices 110 and 120. In certain embodiments, the message tool 230 subscribes to one or more event queues 250 and/or one or more message queues 260. The platform 150 may post messages to particular queues (e.g., event queues 250 and/or message queues 260), based on actions performed one or more components within the platform 150. For example, when the form creation component 158 creates and autofills a digital LOA form, it may post a message to an event queue 250. This message within the event queue 250 may trigger the notification component 156 to generate a request for a user to approve the digital LOA form (e.g., “LOA Approval Request”). In another example, when the access component 154 completes an account transfer with a bank account 170, the access component 154 may post a message to an event queue 250 that triggers the notification component 156 to generate a message with an indication of the completed account transfer.

The message tool 230 may post messages to send to the computing systems 110 and 120 to a message queue 260. These messages, for example, can include a request for a user to approve a digital LOA form, a message indicating approval of a digital LOA form, a message indicating denial of a digital LOA form, a message indicating a completed account transfer, etc. A computing function associated with the message queue 260 can call the API gateway 210 in order to send the message(s) to the computing device 110 and/or computing device 120. In certain embodiments, the event queues 250 and/or message queue(s) 260 may be implemented using a cloud computing message queuing service, such as Amazon Simple Queue Service (SQS).

In certain embodiments, one or more components of the platform 150 may include an event-driven computing engine (also referred to as an event-driven computing service) that performs operations of the respective component(s). An event-driven computing engine can invoke (or execute) predefined functions in response to some triggering event. The event-driven computing engine can provide a serverless compute service that runs application code (e.g., functions) in response to events and automatically manages underlying compute resources used to execute the application code. One example of an event-driven computing engine is Amazon Lambda.

As a reference example, in certain embodiments, the authorization component 152 and/or the form creation component 158 may perform actions using predefined functions executed (or invoked) by an event-driven computing engine, such as Lambda. In these embodiments, a LOA generation request may be placed in an event queue 250, for example, when an API request (“Create LOA Request”) is received. This LOA generation request may be the triggering event that prompts the generation tool 220 to obtain the digital LOA form from the database(s) 272, e.g., using predefined functions executed as part of an event-driven computing engine. The retrieval of the digital LOA form from the database(s) 272 may serve as another triggering event that prompts the form creation component 158 to execute predefined functions (as part of an event-driven computing engine) in order to auto-populate the one or more fields of the digital LOA form.

In this manner, certain embodiments can leverage event queues (e.g., SQS queues) and event-driven computing engines to handle multiple LOA generation requests.

Note that FIG. 2 depicts a reference example of components that can be used to implement the generation of a digital LOA and is not intended as the sole implementation, as other components/architectures for generating a digital LOA can be used.

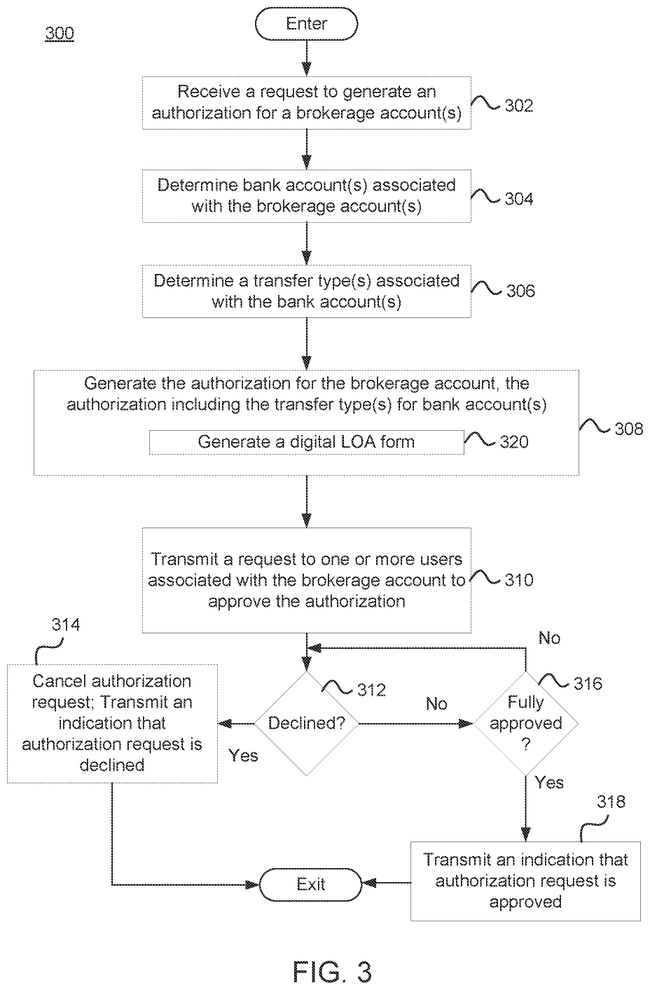

FIG. 3 is a flowchart of an example method 300 for generating a digital LOA authorizing a user (e.g., registered investment advisor) to move funds on behalf of another user (e.g., client), according to certain embodiments. The method 300 may be performed by a computing system (e.g., platform 150). Note that the while the method 300 is described for generating a digital LOA for ACH transfers, in certain other embodiments, a similar method may be used to generate a digital LOA for other types of transfers, including, for example, internal transfers, wire transfers, etc.

Method 300 enters at block 302, where the computing system receives a request to generate an authorization for a brokerage account(s) (e.g., brokerage account(s) 160).

At block 304, the computing system determines one or more bank accounts associated with the brokerage account(s).

At block 306, the computing system determines a transfer type(s) associated with the one or more bank accounts.

At block 308, the computing system generates the authorization for the brokerage account(s). In certain embodiments, generating the authorization includes generating a digital LOA form (block 320) (e.g., an electronic transfer authorization form). For example, the authorization may include a digital LOA. The computing system can select the digital LOA (e.g., from database(s) 272), auto-populate one or more fields of the digital LOA with data including the client's bank account information and/or brokerage account information (e.g., assuming the brokerage account is linked to a bank account). The digital LOA also includes permissions for the transfer type(s) for the bank account(s).

At block 310, the computing system transmits a request to one or more users associated with the brokerage account(s) to approve the authorization. The request may include the digital LOA or a link that allows the one or more users associated with the brokerage account(s) to access (or view) the digital LOA (e.g., which may be hosted or stored in the platform 150).

At block 312, the computing system determines whether the authorization has been declined. The computing system may determine that the authorization has been declined if at least one of the users associated with the brokerage account(s) declines the digital LOA. If the authorization has been declined, the computing system cancels the authorization request and transmits an indication that the authorization request is declined (block 314). The method 300 then exits.

On the other hand, if the computing system determines the authorization has not been declined, the computing system determines whether the authorization has been fully approved by the one or more users. For example, in cases where there are multiple account owners of a bank account, the digital LOA may have to be approved by each of the account owners. In these cases, if the computing system has not received an approval from all of the account owners, the computing system determines the authorization has not yet been fully approved and proceeds to block 312. On the other hand, if the computing system has received an approval from all of the account owners, the computing system transmits an indication that the authorization request is approved (block 318), and the method 300 exits.

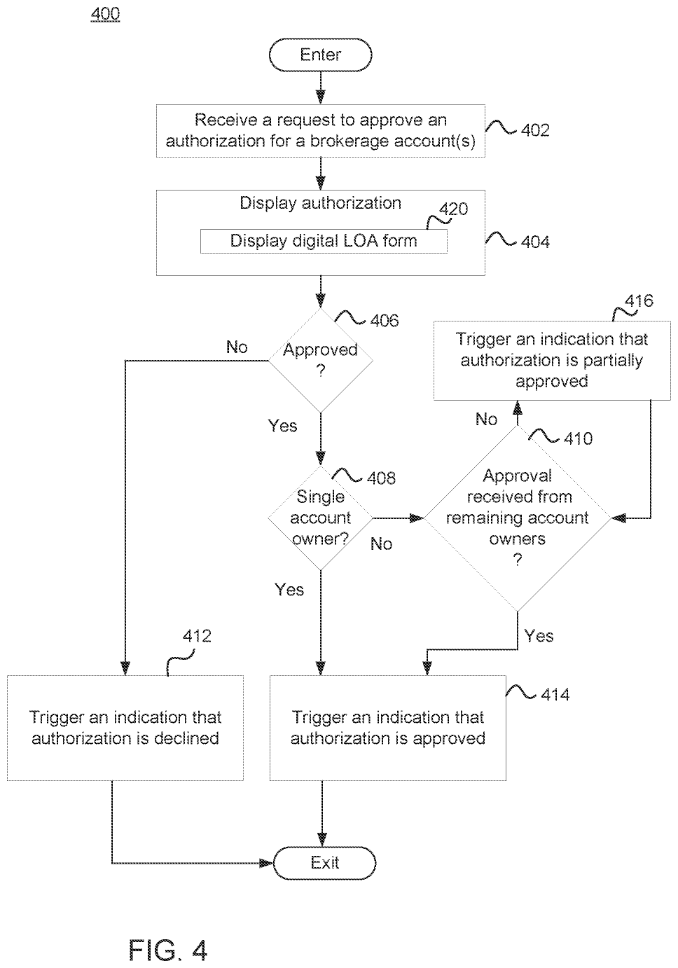

FIG. 4 is a flowchart of an example method 400 for generating a response to a request to approve a digital LOA, according to certain embodiments. The method 400 may be performed by a computing system (e.g., computing device 120).

Method 400 enters at block 402, where the computing system receives a request to approve an authorization for a brokerage account(s) (e.g., brokerage account(s) 160). The authorization includes a digital LOA with permissions authorizing a user (e.g., registered investment advisor) to move funds on behalf of the user (e.g., client) of the computing system. The platform 150 may transmit a message to the computing system that includes the digital LOA or a link to the digital LOA.

At block 404, the computing system displays the authorization (e.g., via a user interface of the computing system). In certain embodiments, displaying the authorization includes displaying the digital LOA form that is generated by the platform 150 (block 420). For example, the computing system may display the digital LOA on the user interface of the computing system. In certain embodiments, the computing system may interact with the platform 150 in order to display the digital LOA. For example, the computing system may access the platform 150, via the application 102 and/or browser 106, and retrieve the digital LOA from a storage system (e.g., document service 190, database(s) 166, etc.) within the platform 150. In certain embodiments, the computing system may send an API call (e.g., “GET/authorization”) in order to retrieve the digital LOA from the platform 150.

At block 406, the computing system determines whether the authorization has been approved. For example, the computing system may present an “Approve” prompt on a user interface allowing the user to indicate that the digital LOA is approved and a “Decline” prompt on the user interface allowing the user to indicate that the digital LOA is declined. If the computing system determines that the authorization is declined, then the computing system triggers an indication that the authorization is declined and transmits the indication to the platform 150 (block 412).

On the other hand, if the computing system determines that the authorization is approved, the computing system determines whether the bank account indicated in the digital LOA is associated with a single account owner or multiple account owners (block 408). If the bank account is associated with a single account owner, then the computing system triggers an indication that the authorization is approved and transmits the indication to the platform 150 (block 414). If the bank account is associated with multiple account owners, then the computing system determines whether approval has been received from the remaining account owners (block 410). If so, then the computing system proceeds to block 414. If not, then the computing system triggers an indication that the authorization is partially approved (block 416).

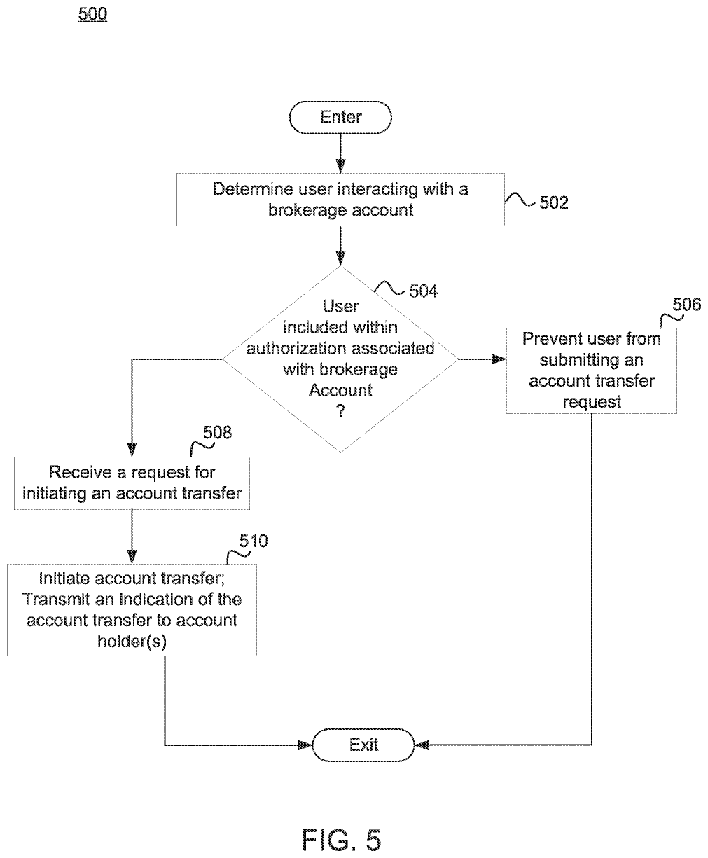

FIG. 5 is a flowchart of an example method 500 for initiating an account transfer based on authorization, according to certain embodiments. The method 500 may be performed by a computing system (e.g., platform 150).

Method 500 enters at block 502, where the computing system identifies a user interacting with a brokerage account. For example, a user (e.g., registered investment advisor) may be interacting with the platform 150 via the computing system 110. At block 504, the computing system determines whether the user interacting with the brokerage account is included within an authorization (including a digital LOA) associated with the brokerage account. If not, then the computing system may not allow the user to submit a request to initiate an account transfer (block 506), and the method 500 may exit.

If the user is included within the authorization, then the computing system may allow the user to submit a request to initiate an account transfer for the brokerage account. For example, at block 508, the computing system receives a request for initiating an account transfer. At block 510, the computing system initiates the account transfer and transmits an indication of the account transfer to the account holder(s).

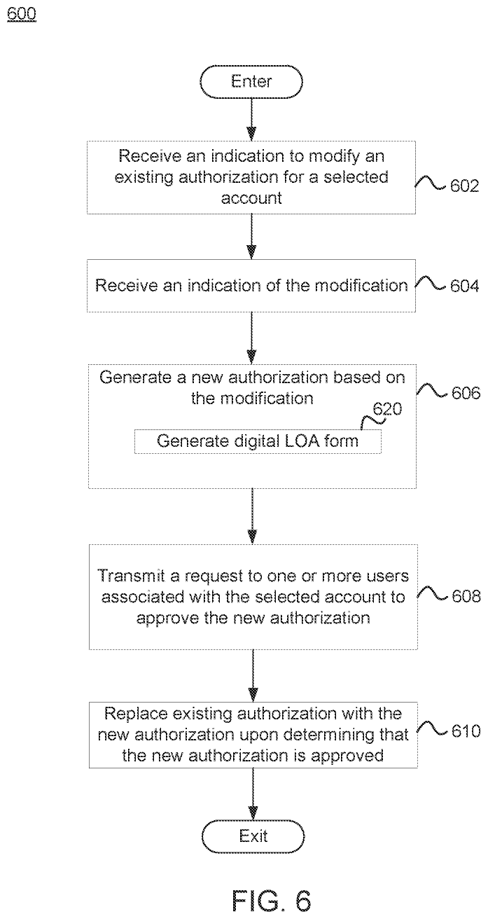

FIG. 6 is a flowchart of an example method 600 for modifying an authorization, according to certain embodiments. The method 600 may be performed by a computing system (e.g., platform 150).

Method 600 enters at block 602, where the computing system receives an indication to modify an existing authorization for a selected account. The existing authorization includes an existing digital LOA for the selected account. At block 604, the computing system receives an indication of the modification. The modification can include at least one of: a removal of a bank account from the digital LOA, an addition of a bank account to the digital LOA, an update to the type of transfer for a bank account in the digital LOA, etc.

At block 606, the computing system generates a new authorization based on the modification. The computing system may generate the new authorization by generating a new digital LOA, based on the modification (block 620). At block 608, the computing system transmits a request to one or more users associated with the selected account to approve the new authorization (including the new digital LOA).

At block 610, the computing system replaces the existing authorization with the new authorization, upon determining that the new authorization is approved.

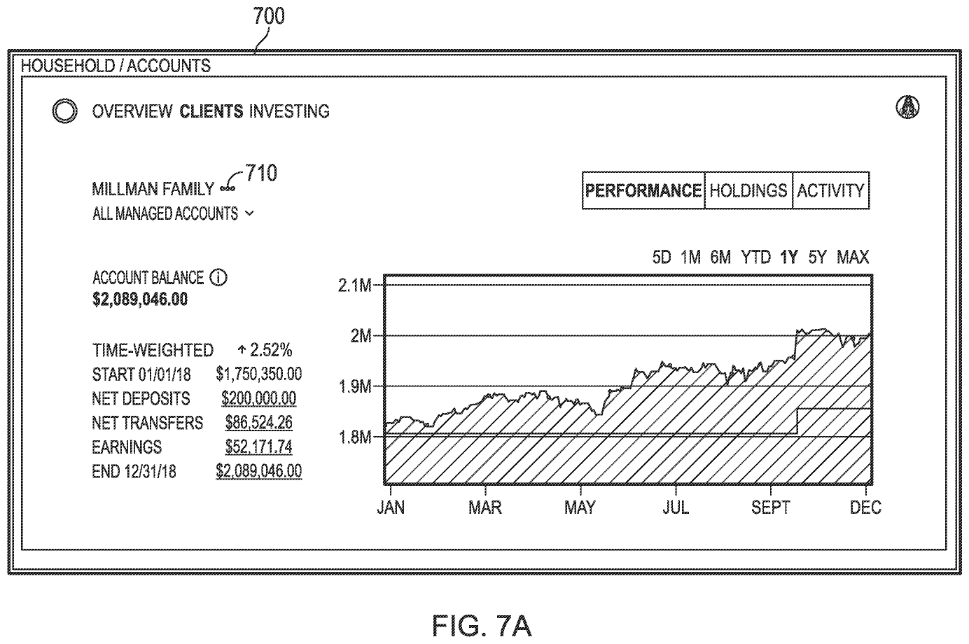

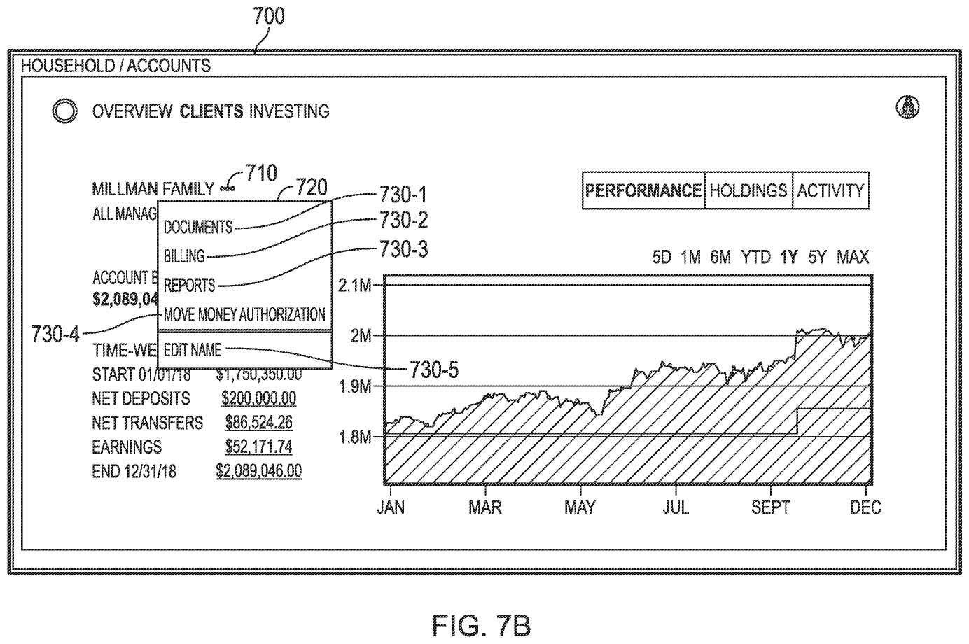

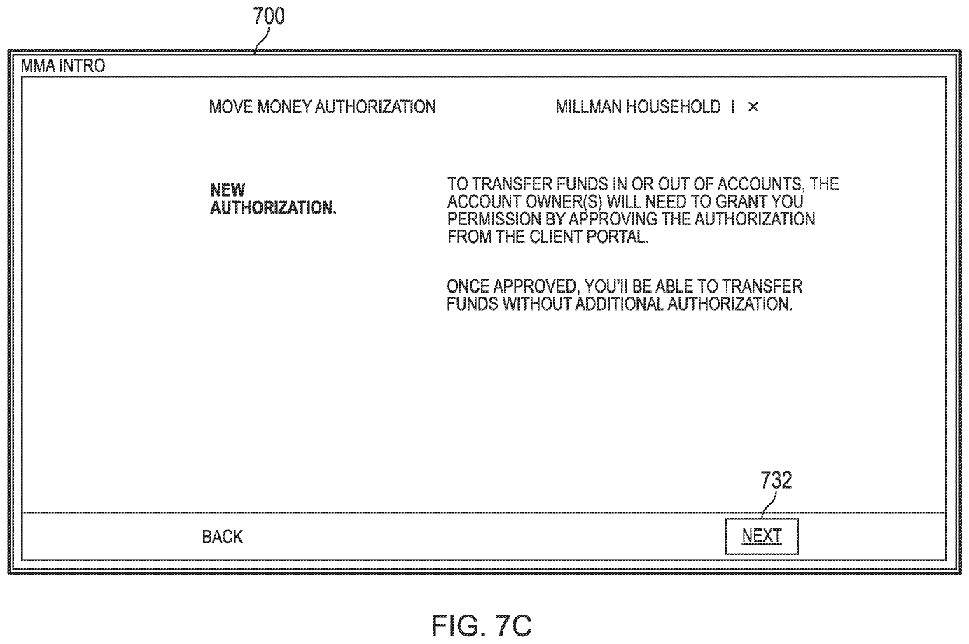

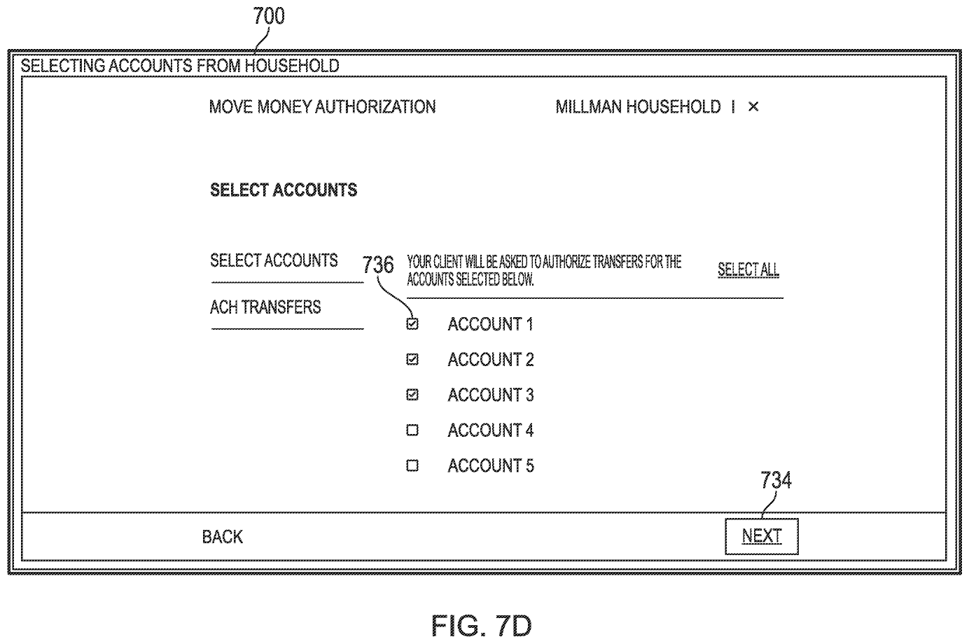

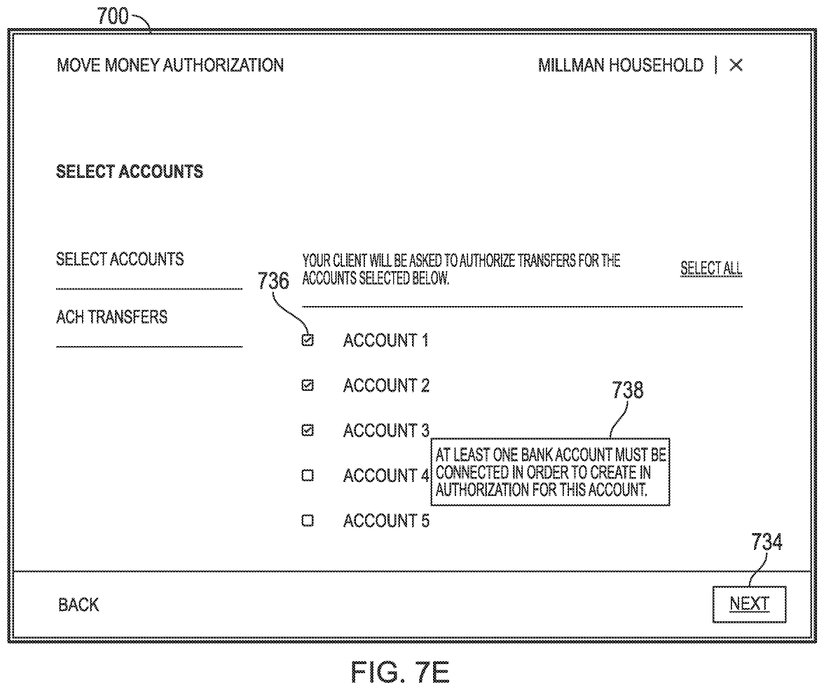

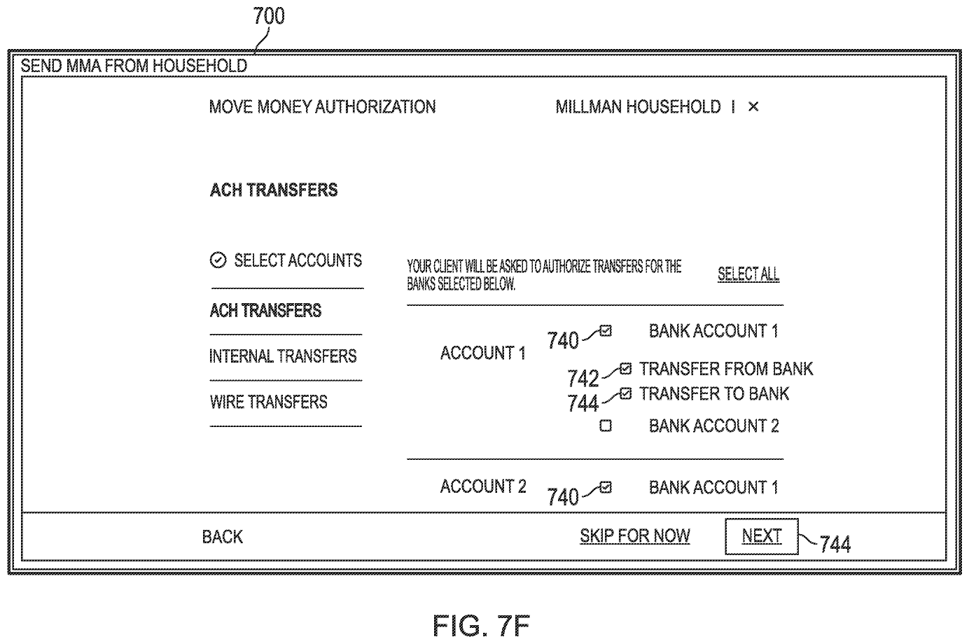

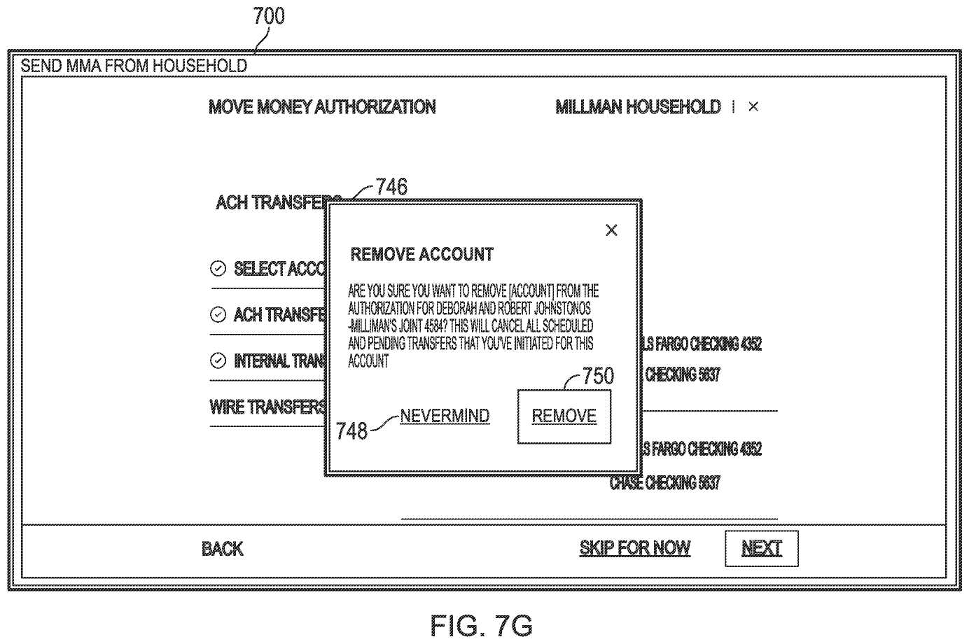

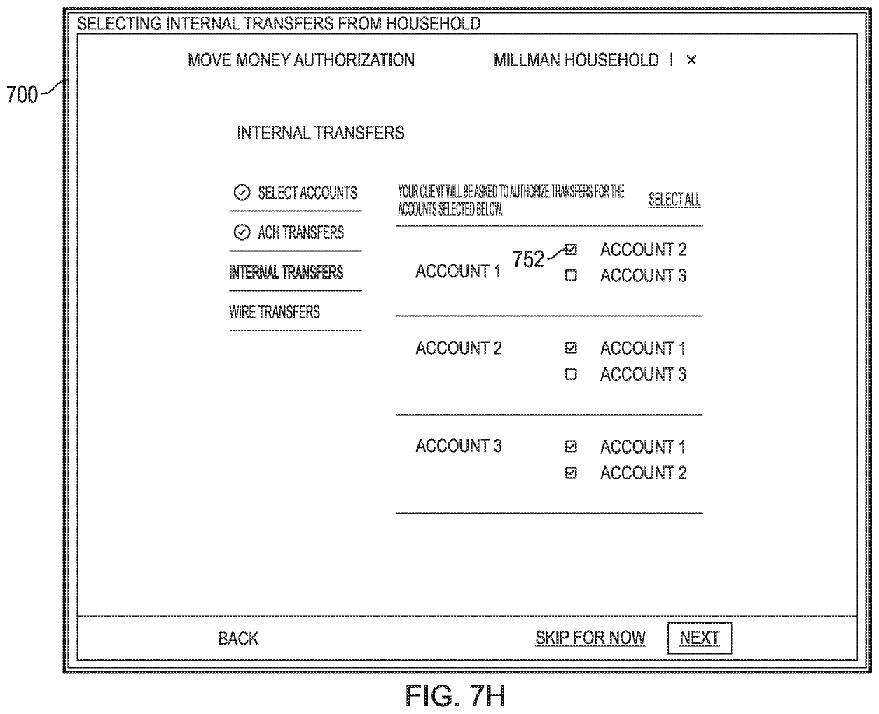

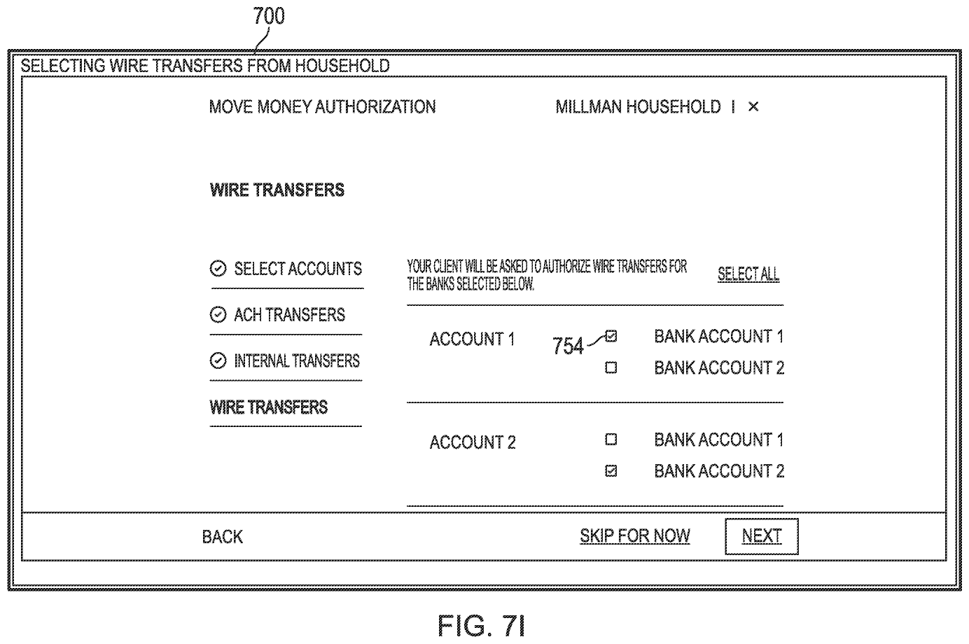

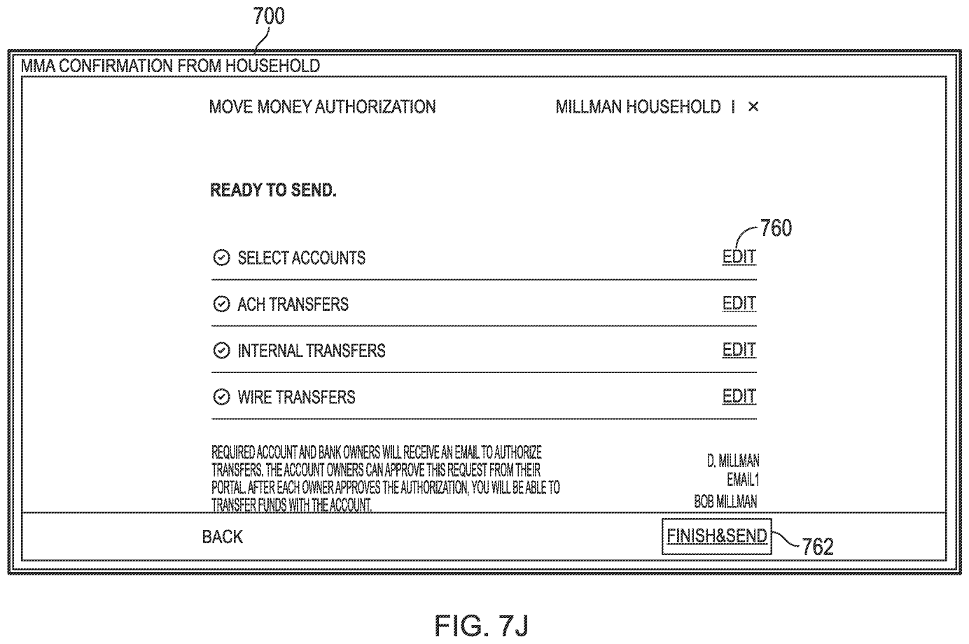

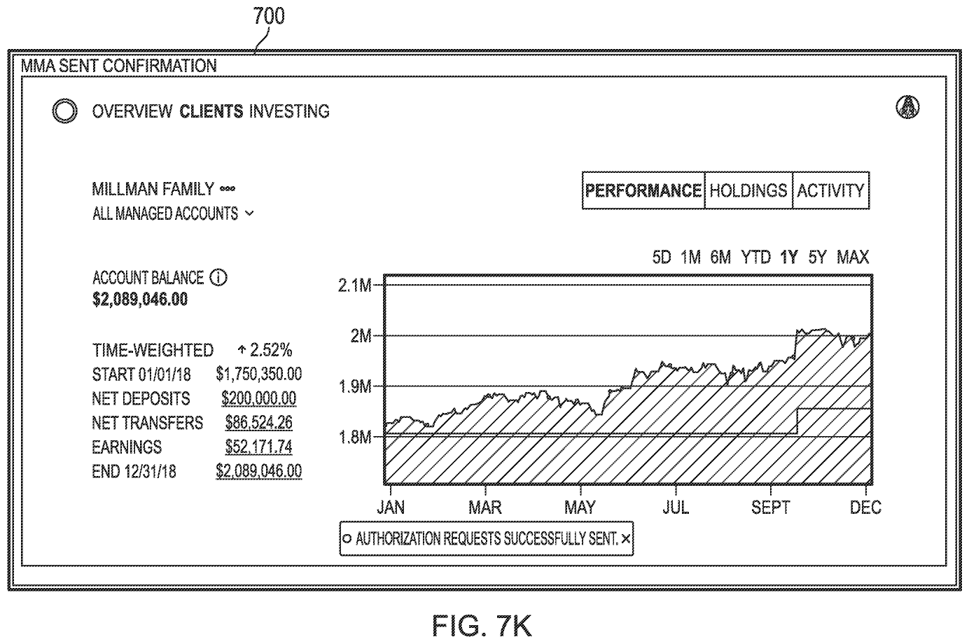

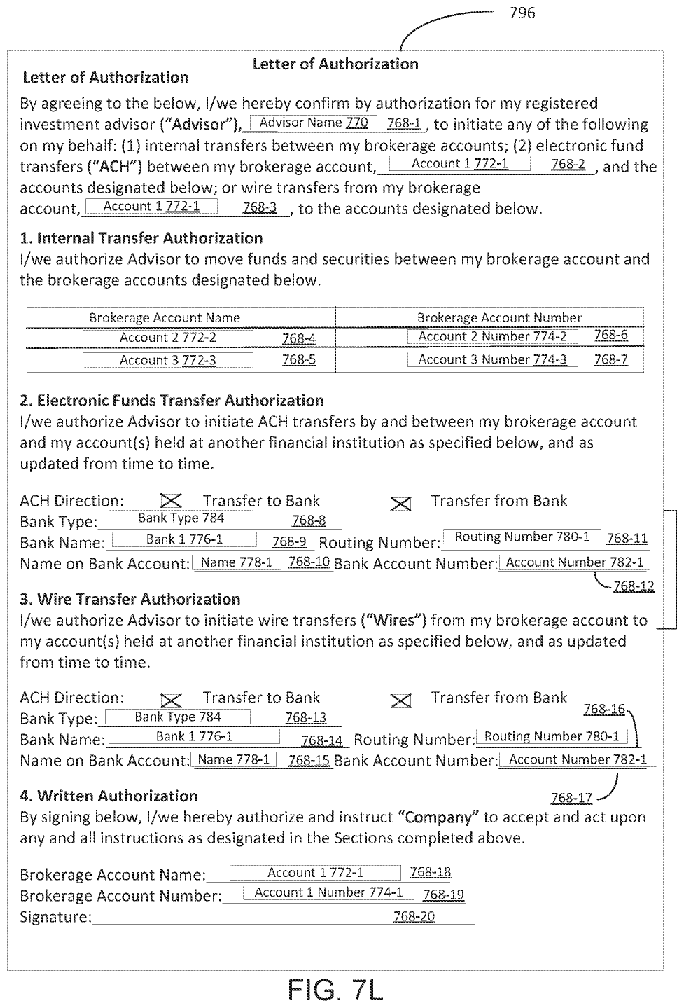

FIGS. 7A-7L depict an example sequence of a user interaction with an application to generate a digital LOA, according to certain embodiments. As shown in the user interface 700 of FIG. 7A, the user, e.g., registered investment advisor, is presented with an initial screen that includes information pertaining to a household account. The information indicates, for example, an estimated current account balance, a starting account balance on a particular day, ending account balance on a particular day, net deposits, net transfers, earnings, etc. As shown, the user may also be presented with a figure/chart that shows the performance of the household account over a predefined duration (e.g., number of days, number of months, number of years, etc.).

The user interface 700 also includes a prompt 710 on the initial screen, which allows the user to view/select additional options provided by the application for the household account. As shown in FIG. 7B, when the user selects the prompt 710, the user is presented with a window 720 that shows an overflow menu with multiple fields 730. Here, for example, the overflow menu includes a “Documents” field 730-1, a “Billing” field 730-2, a “Reports” field 730-3, a “New Authorization” field 730-4, and an “Edit Name” field 730-5. The window 720 may be a modal window or a non-modal window. In certain embodiments, the user can select the “New Authorization” field 730-4 to initiate a request for a digital LOA for this household account.

As shown in FIG. 7C, assuming the user selects the “New Authorization” field 730-4, the user is presented with an introduction screen that provides information about the workflow for generating the digital LOA. Here, for example, the introduction screen indicates that the user will have to get permission from the account owner(s) in order to transfer funds in or out of accounts. The user can select the prompt 732 to proceed with the workflow for generating the digital LOA.

As shown in FIG. 7D, assuming the user selects the prompt 732, the user is presented with an account selection screen that indicates a set of brokerage accounts (Accounts 1-5) associated with the household account. The set of brokerage accounts can include different types of brokerage accounts, including, for example, individual accounts, joint accounts, IRA accounts, etc. The set of brokerage accounts can also include accounts for different users in the household. For example, Account 1 may be an individual account for Person A in the household, Account 2 may be an individual account for Person B in the household, Account 3 may be a joint account for Person A and Person B, etc. The account selection screen provides a prompt 736 for each brokerage account that allows the user to select/deselect the accounts that will be associated with the digital LOA. Each account that is selected may have its own digital LOA. Here, the user selects the prompt 736 for Accounts 1-3 in order to generate a different authorization for each of the Accounts 1-3. The user can select the prompt 734 to proceed with the selected accounts.

In certain embodiments, the account selection screen may indicate brokerage account(s) that are not yet open (e.g., an account creation requests may have been sent but not yet approved by a client), but may not allow the user to select the brokerage account using the prompt 736 for that brokerage account. For example, the account selection screen may deactivate the prompt 736 for the inactive brokerage account. Similarly, in certain embodiments, the account selection screen may indicate brokerage account(s) that do not have an associated bank account linked to the brokerage account, but may not allow the user to select the brokerage account using the prompt 736 for that brokerage account. As shown in FIG. 7E, for example, the account selection screen presents a tooltip 738, indicating that at least one bank account has to be linked or connected to Account 4 in order for the user to create an authorization for Account 4. In certain embodiments, the tooltip 738 may be presented upon detecting the user's interaction with the prompt 736 for Account 4. For example, the user's interaction may be detected based on a “trigger event,” examples of which can include, but are not limited to, a click event, a “mouseover” event, a “mouseenter” event, a “hover” event, etc.

As shown in FIG. 7F, once the user selects the set of brokerage accounts to associate with the authorization, the user is presented with a transfer selection screen (for ACH transfers) that indicates a set of bank accounts linked to each of the selected set of brokerage accounts. Note for the sake of clarity, FIG. 7F shows the set of bank accounts linked for two of the three brokerage accounts selected in FIG. 7D (e.g., Accounts 1-2). Here, for example, the transfer selection screen indicates that “Bank Account 1” and “Bank Account 2” are associated with Account 1 and that “Bank Account 1” is associated with Account 2. The transfer selection screen also presents a prompt 740 that allows the user to select/deselect the bank account(s) that will be included in the authorization for each of the set of brokerage accounts. In FIG. 7F, for example, the user selects the prompt 740 for Bank Account 1 of Account 1 and selects the prompt 740 for Bank Account 1 of Account 2.

Additionally, the transfer selection screen can present a prompt 742 that allows the user to select/deselect a first type of transfer (e.g., Transfer from bank) and a prompt 744 that allows the user to select/deselect a second type of transfer (e.g., Transfer to bank) for each bank account. In FIG. 7F, for example, the user selects prompt 742 and prompt 744 for Bank Account 1 associated with Account 1. Once the set of bank accounts and/or types of transfers for each bank account are selected, the user can select prompt 744 to proceed with the workflow for generating the authorization.

In certain embodiments, a user may attempt to deselect a bank account from a brokerage account that has an existing authorization in place. In these embodiments, as shown in FIG. 7G, the user can be presented with a window 746 alerting that if the bank account is removed, it may cancel scheduled and pending transfers associated with the brokerage account. The window 746 can include a prompt 748 that allows the user to cancel the removal and a prompt 750 that allows the user to proceed with the removal. The window 746 may be a modal window or a non-modal window.

While certain embodiments described herein use “ACH transfers” as a type of transfer that may be included within an authorization, certain embodiments also allow users to generate authorizations that authorize the users to perform other types of transfers (e.g., internal transfers, wire transfers, etc.) on behalf of clients. As shown in FIG. 7H, for example, the user is presented with a transfer selection screen for Internal Transfers. The Internal Transfers may be between brokerage accounts, such as between any of Accounts 1-3 selected in FIG. 7D. The transfer selection screen provides a prompt 752 that allows the user to select/deselect a set of brokerage accounts to include within the authorization for a given brokerage accounts. As shown, the user selects the prompt 752 to authorize transfers between Account 2 and Account 1, transfers between Account 3 and Account 1, and transfers between Account 3 and Account 2.

As shown in FIG. 7I, the user is presented with a transfer selection screen for Wire Transfers. The Wire transfers may be between brokerage accounts and other bank accounts, which may or may not be linked to the brokerage accounts. The transfer selection screen provides a prompt 754 that allows the user to select/deselect a set of bank accounts to include within the authorization for a given brokerage account. As shown, the user selects the prompt 754 to authorize wire transfers between Account 1 and Bank Account 1 and transfers between Account 2 and Bank Account 2.

Once the user has completed the transfer selection screen(s) for the different types of transfers (e.g., ACH transfers, internal transfers, wire transfers, etc.), the user is presented with a confirmation screen that allows the user the option to re-enter the workflow by selecting one of the prompts 760 (e.g., as shown in FIG. 7J). The confirmation screen may also indicate that the associated account holders will receive a message to approve the LOA, and that after approval, the user will be able to transfer funds with the account. The user may select the prompt 762 to trigger generation of the LOA based on the user selections. Assuming the user selects prompt 762, the user may be returned to the initial screen, which presents a prompt 764 indicating that the authorization requests have been sent (e.g., as shown in FIG. 7K).

FIG. 7L illustrates an example of a digital LOA form 796 that may be automatically generated using the techniques described herein, according to certain embodiments. Here, the digital LOA form 796 is generated for a brokerage account “Account 1” and outlines what types of activities are authorized on the brokerage account. As shown, the digital LOA form 796 includes an introduction section with fields 768 1-3, an internal transfer authorization section with fields 768 4-7, an electronic funds transfer authorization section with fields 768 8-12, a wire transfer authorization section with fields 768 13-17, and a written authorization section with fields 768 18-20.

Based on the user's interaction with the platform 150 (e.g., as shown in the various screens depicted in FIGS. 7A-7K), the platform 150 may automatically populate the fields 768 with the applicable information. For example, for the introduction section, the platform 150 may populate field 768-1 with the name of the registered investment advisor (e.g., advisor name 770), and populate field 768-2 and field 768-3 with the name of the brokerage account (e.g., Account 1 772-1).

For the internal transfer authorization section, the platform 150 may automatically populate field 768-4 with the name of another brokerage account (e.g., Account 2 772-2) and field 768-6 with the account number for that brokerage account (e.g., Account 2 Number 774-2). Similarly, the platform 150 may populate 768-5 with the name of another brokerage account (e.g., Account 3 772-3) and field 768-7 with the account number for that brokerage account (e.g., Account 3 Number 774-3).

For the electronics funds transfer authorization, the platform 150 may automatically select/deselect prompts for the applicable ACH direction “Transfer to Bank” and/or “Transfer from Bank.” The platform 150 may also populate field 768-8 with the bank type (e.g., Bank Type 784), populate field 768-9 with the name of the bank (e.g., Bank 1 776-1), populate field 768-10 with the name on the bank account (e.g., Name 778-1), populate field 768-11 with the routing number for the bank account (e.g., Routing Number 780-11), and populate field 768-12 with the account number for the bank account (e.g., Account Number 782-1).

For the wire transfer authorization section, the platform 150 may automatically select/deselect prompts for the applicable ACH direction “Transfer to Bank” and/or “Transfer from Bank.” The platform 150 may also populate field 768-13 with the bank type (e.g., Bank Type 784), populate field 768-14 with the name of the bank (e.g., Bank 1 776-1), populate field 768-15 with the name on the bank account (e.g., Name 778-1), populate field 768-16 with the routing number for the bank account (e.g., Routing Number 780-11), and populate field 768-17 with the account number for the bank account (e.g., Account Number 782-1).

For the written authorization section, the platform 150 may populate field 768-18 with the name of the brokerage account (e.g., Account 1 772-1), and populate field 768-19 with the account number for the brokerage account (e.g., Account 1 Number 774-1). The platform 150 may populate the field 768-20 with the signature of the user, once the user accepts the digital LOA form 796.

Note the digital LOA form 796 depicted in FIG. 7L is a reference example of a digital LOA form that may be automatically generated using the techniques described herein. In other certain embodiments, the digital LOA form 796 may include any number of fields 768 and/or different information content, depending on the user's interaction with the platform 150. For example, a digital LOA form may have any number of bank accounts listed in the various sections, may omit one or more sections, may have a different number of users listed on a given account, etc.

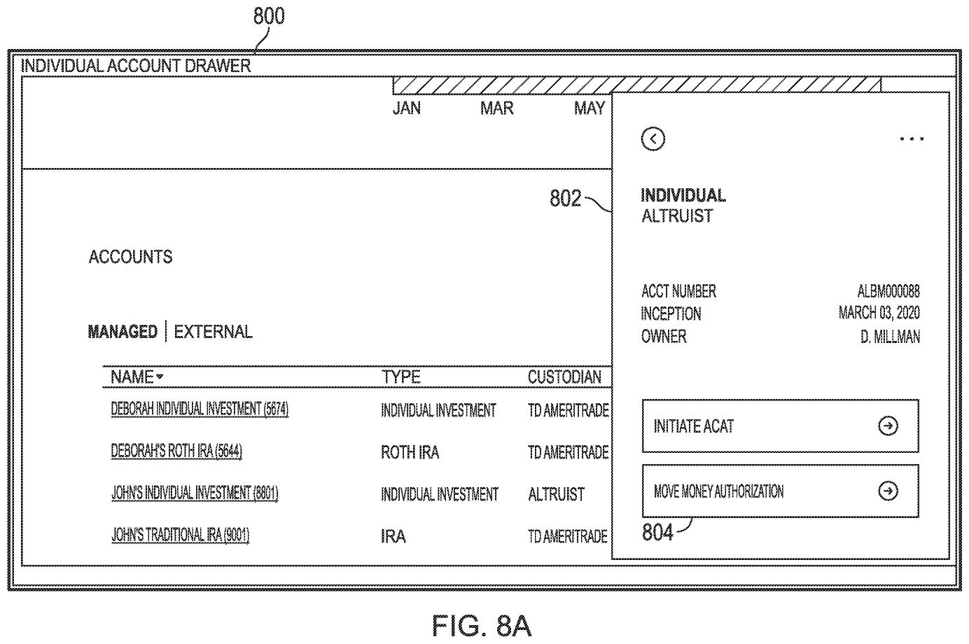

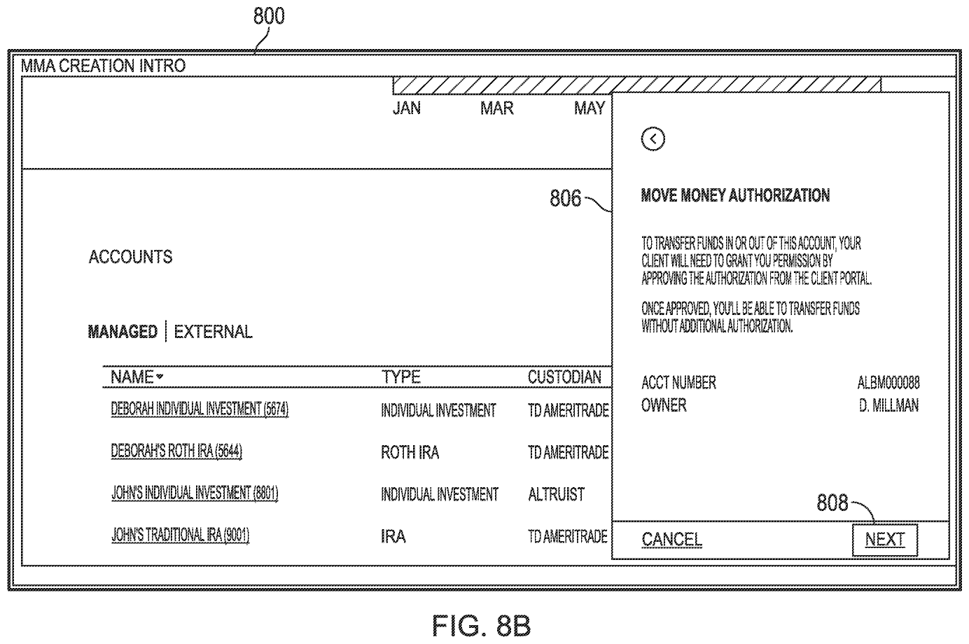

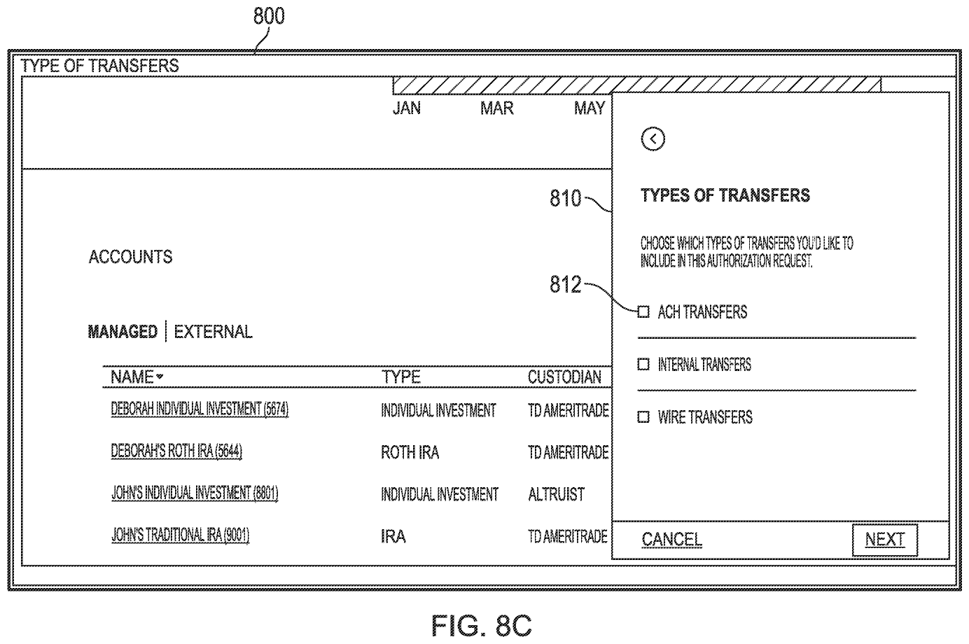

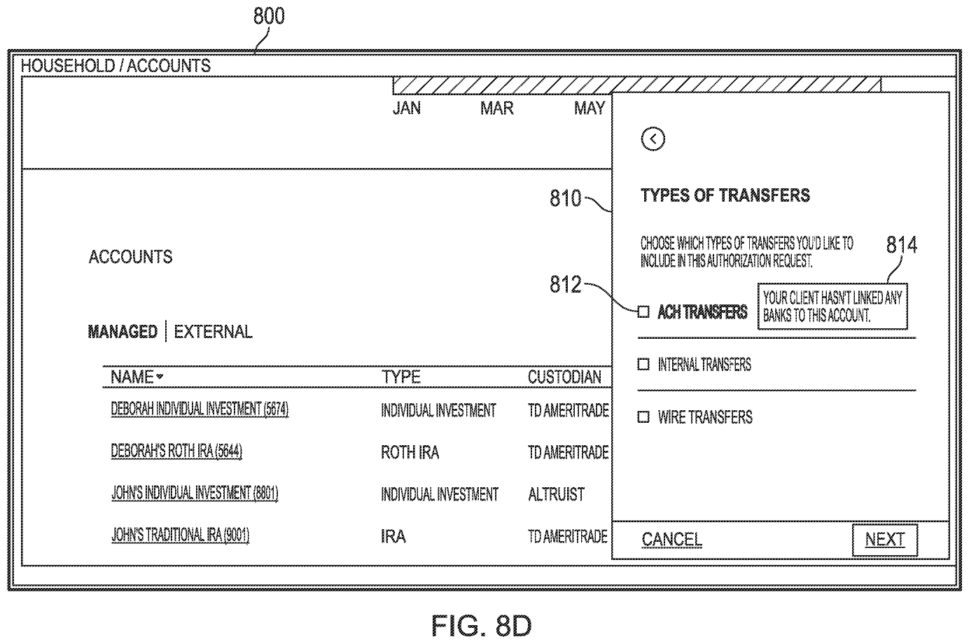

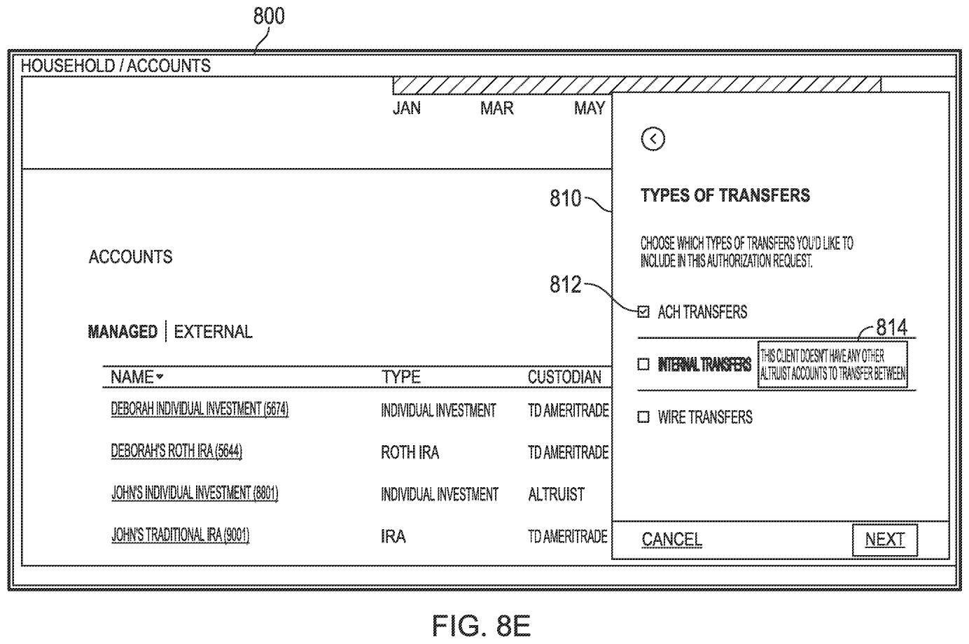

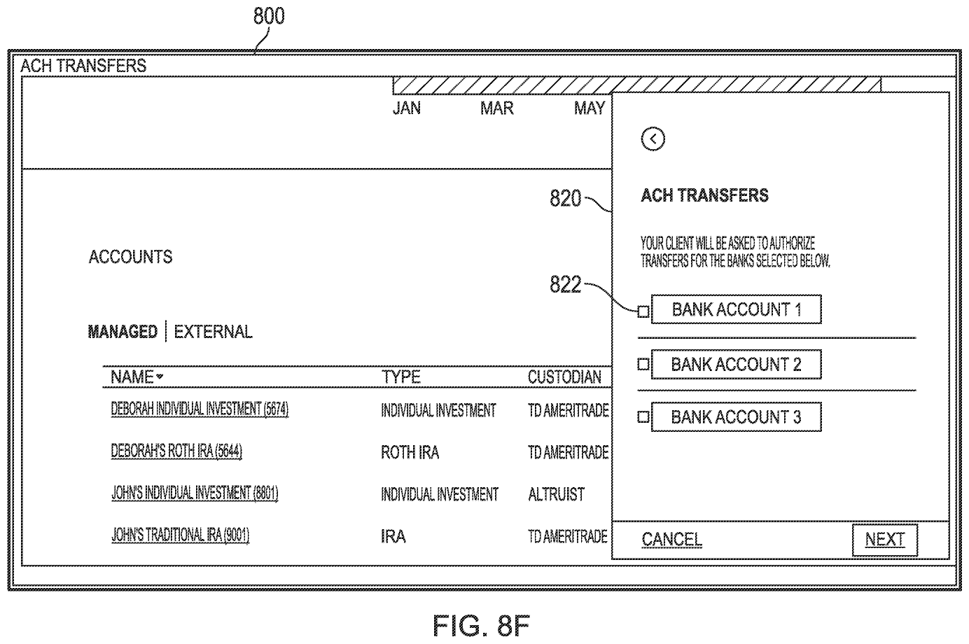

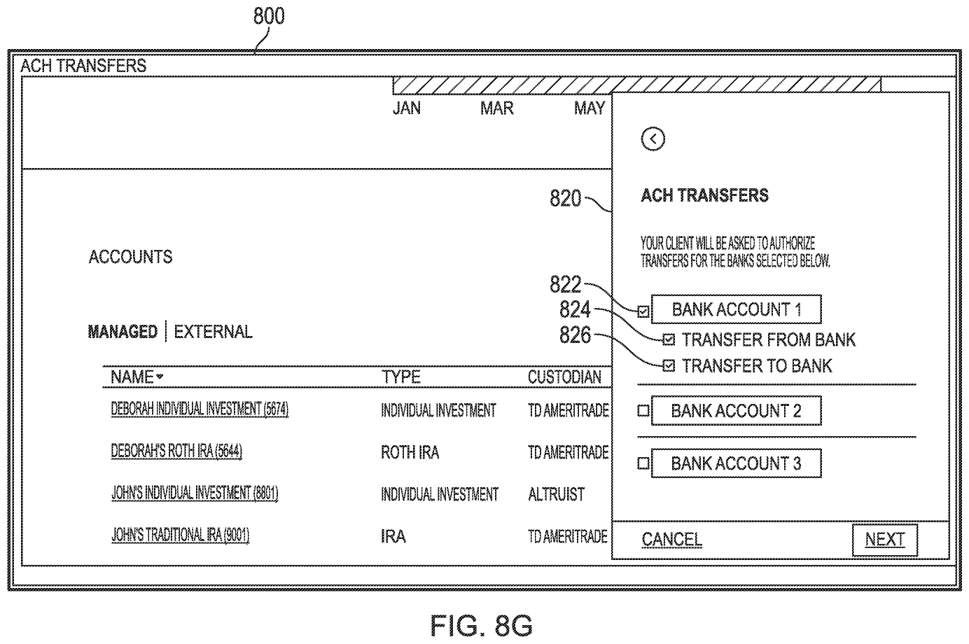

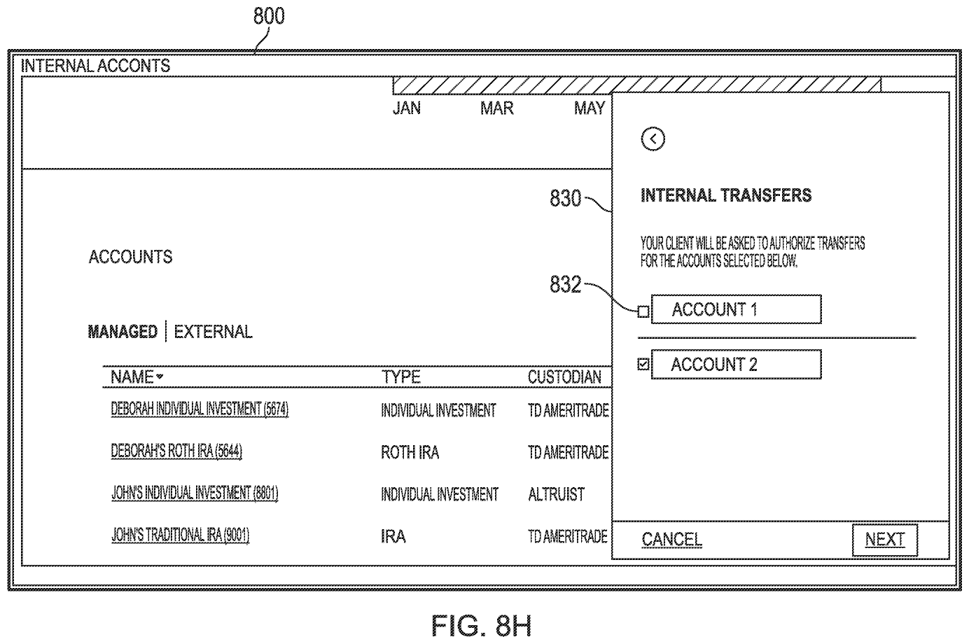

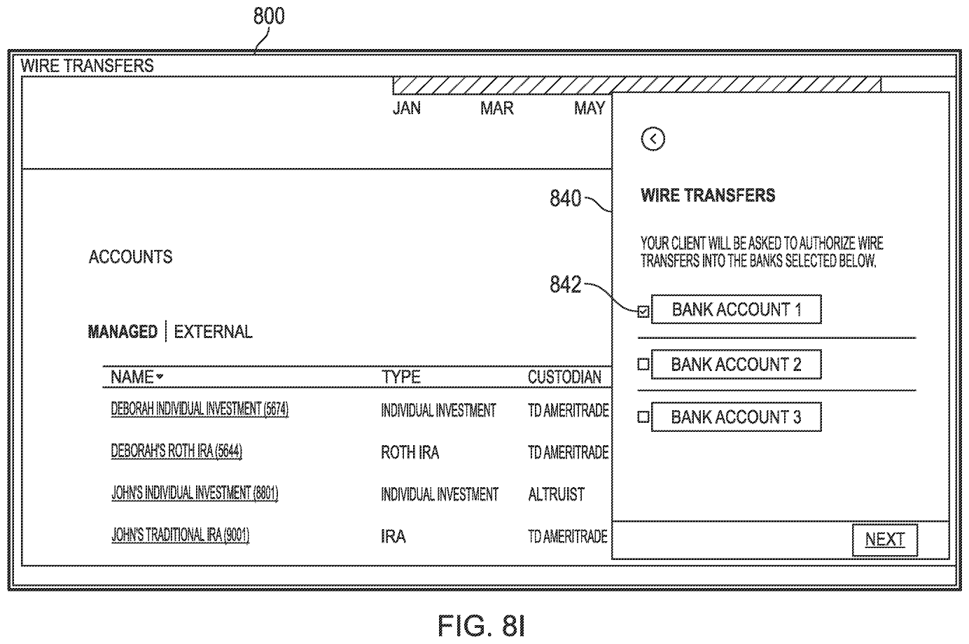

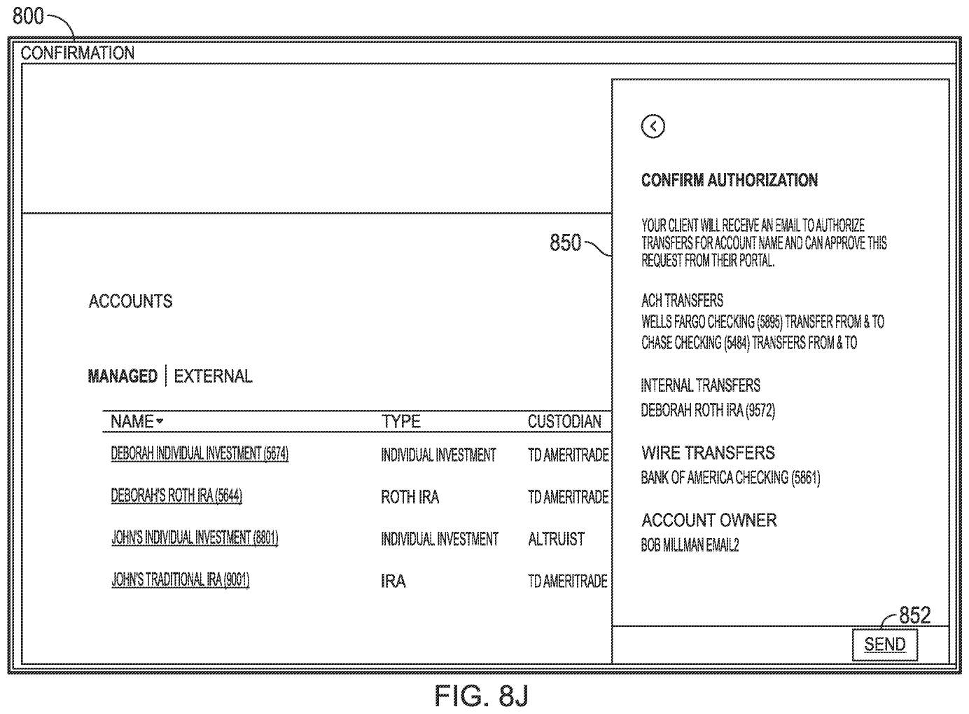

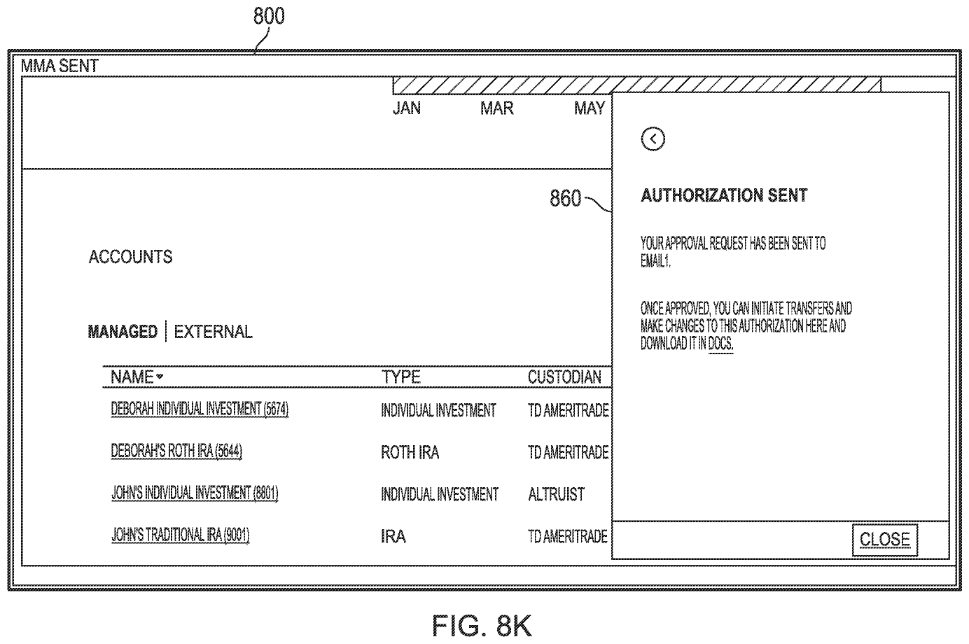

FIGS. 8A-8K depict an example sequence of a user interaction with an application to generate a digital LOA, according to certain embodiments. In this sequence, the user may interact with the application at the individual account level (instead of the household account level) to trigger the generation of a digital LOA. As shown in the user interface 800 of FIG. 8A, the user is presented with an initial screen that includes information pertaining to an individual account. The initial screen includes a window 802 with information such as the account number, inception date, account holder, etc. The window 802 includes a prompt 804 that allows the user to trigger a workflow for generating an authorization for the individual account.

As shown in FIG. 8B, assuming the user selects the prompt 804, the user is presented with a window 806 that provides information about the workflow for generating the digital LOA. Here, for example, the window 806 indicates that the user will have to get permission from the account owner(s) in order to transfer funds in or out of accounts. The user can select the prompt 808 to proceed with the workflow for generating the digital LOA.

As shown in FIG. 8C, assuming the user selects the prompt 808, the user is presented with a transfer selection window 810 with a list of different types of transfers (e.g., ACH transfers, internal transfers, and wire transfers) along with a prompt 812 for each type of transfer that allows the user to select/deselect the type of transfer. In certain embodiments, the transfer selection window 810 may deactivate the prompt 812 if certain condition are not satisfied for one or more of the types of transfers. For example, as shown in FIG. 8D, the window 810 deactivates the prompt 812 for “ACH Transfers,” because the individual account does not have any associated linked bank accounts. In another example shown in FIG. 8E, the window 810 deactivates the prompt 812 for “Internal Transfers,” because the client does not have another brokerage account to initiate transfers to/from the individual account.

The window 810 may present a pop-up 814 with the reason for why the prompt 812 is deactivated. For example, in FIG. 8D, the pop-up 814 indicates that the individual account does not have a linked bank account. In FIG. 8E, the pop-up 814 indicates that another brokerage account is not available for an internal transfer.

Assuming the user selects ACH transfers in the window 810, as shown in FIG. 8F, the user may be presented with a window 820 that indicates a set of bank accounts associated with the individual account (e.g., for ACH transfers). Here, for example, the window 820 indicates three Bank Accounts 1-3 that are associated with the individual account and provides a prompt 822 that allows the user to select/deselect each Bank Account.

In certain embodiments, upon selecting a prompt 822 for a given bank account, the window 820 may present a set of prompts 824, 826 for different types of transfers to include within the authorization for the bank account. As shown in FIG. 8G, for example, when the prompt 822 for Bank Account 1 is selected, the window 820 provides a prompt 824 for “Transfer from bank” and a prompt 826 for “Transfer to bank.” Here, the user selects prompt 824 and prompt 826.

As shown in FIG. 8H, assuming the user selects Internal Transfers in the window 810, the user may be presented with a window 830 that indicates a set of brokerage accounts associated with the individual account (e.g., for internal transfers). Here, for example, the window 830 indicates two Accounts 1-2 that are associated with the individual account and provides a prompt 832 that allows the user to select/deselect each Account.

As shown in FIG. 8I, assuming the user selects Wire Transfers in the window 810, the user may be presented with a window 840 that indicates a set of bank accounts associated with the individual account (e.g., for wire transfers). Here, for example, the window 840 indicates three bank accounts 1-3 that are associated with the individual account and provides a prompt 842 that allows the user to select/deselect each Account.

Once the user has complete the windows for the different types of transfers (e.g., ACH transfers, internal transfers, wire transfers, etc.), the user is presented with a confirmation window 850 that allows the user to view details of their selections (e.g., as shown in FIG. 8J). The user may select the prompt 852 to trigger the request for the generation of the LOA based on the selections. Assuming the user selects prompt 852, the user may be presented with a window 860 indicating that the authorization requests have been sent (e.g., as shown in FIG. 8K).

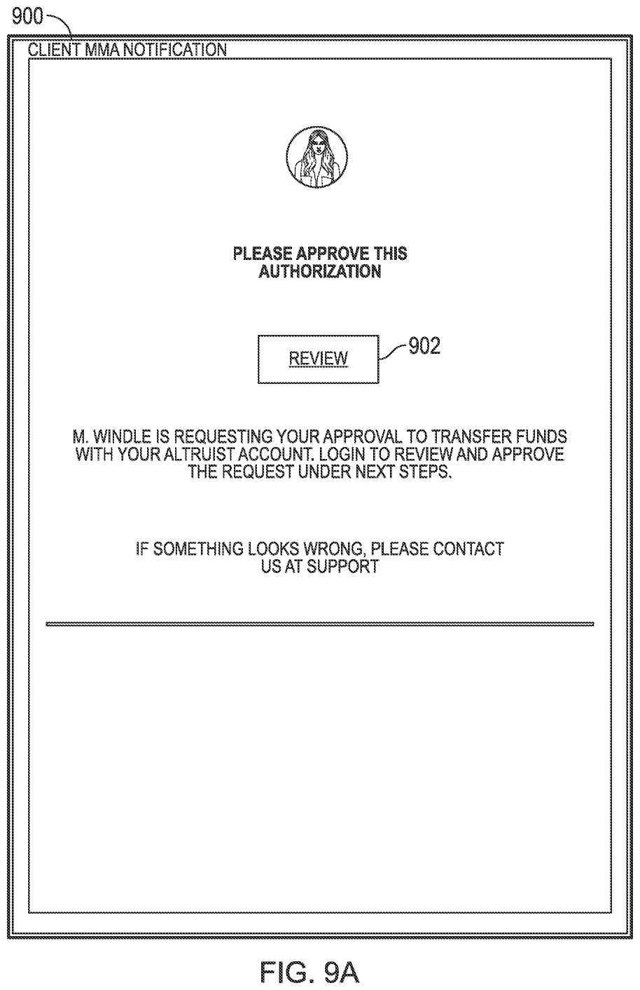

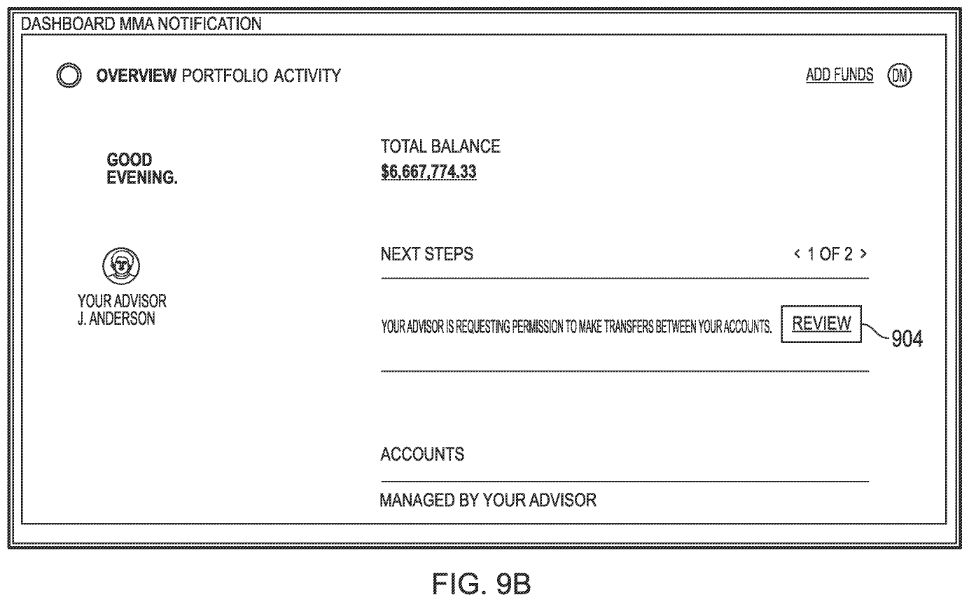

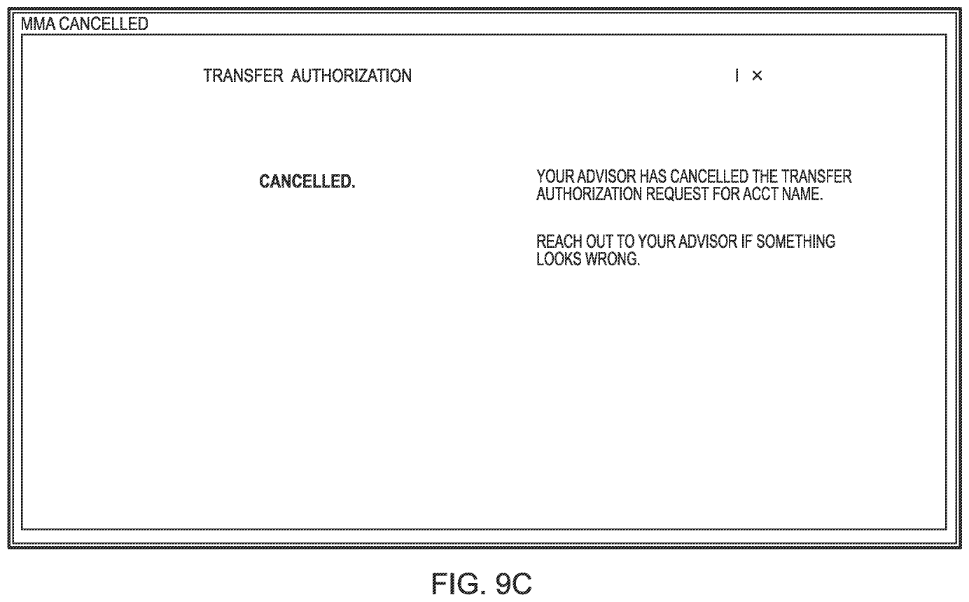

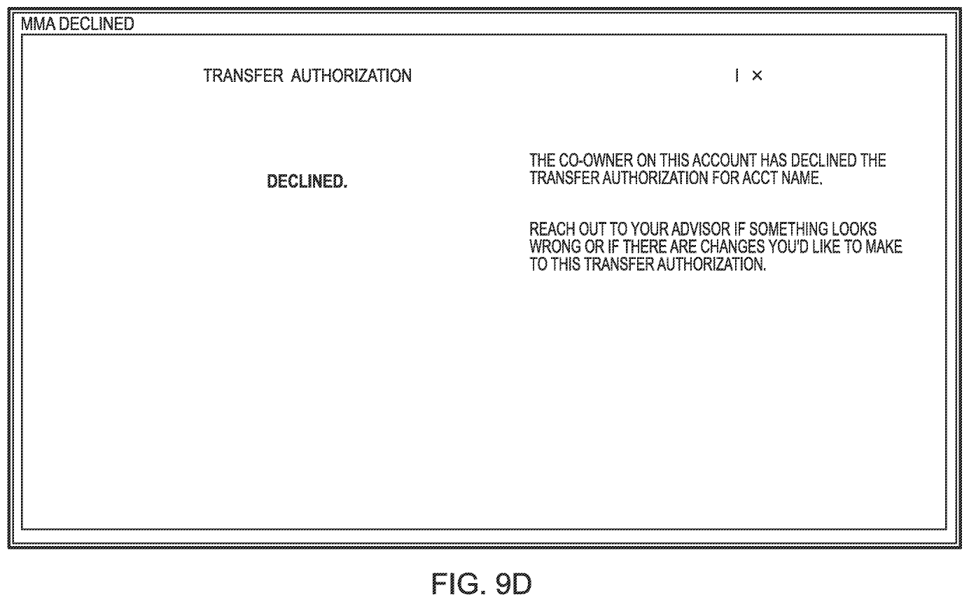

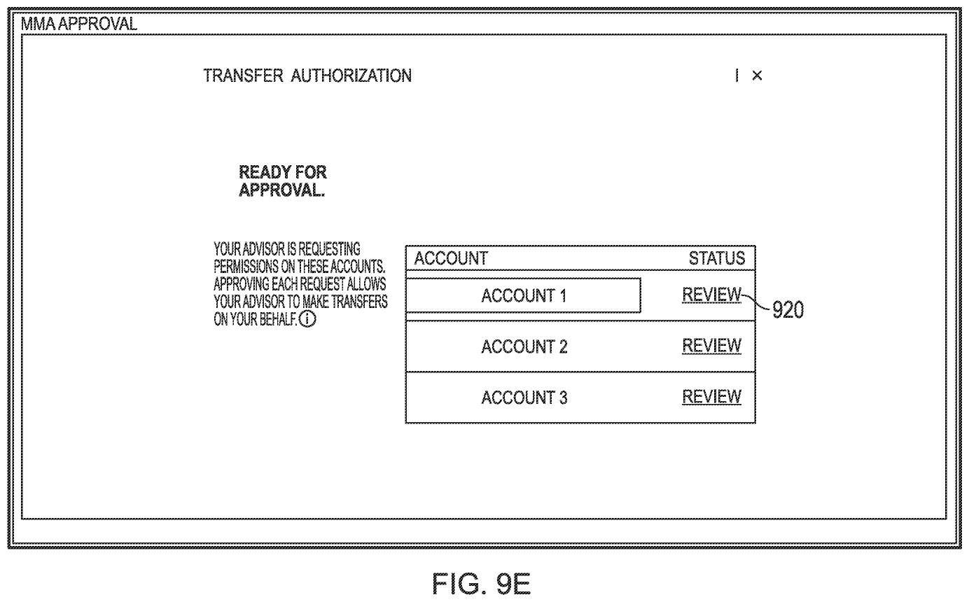

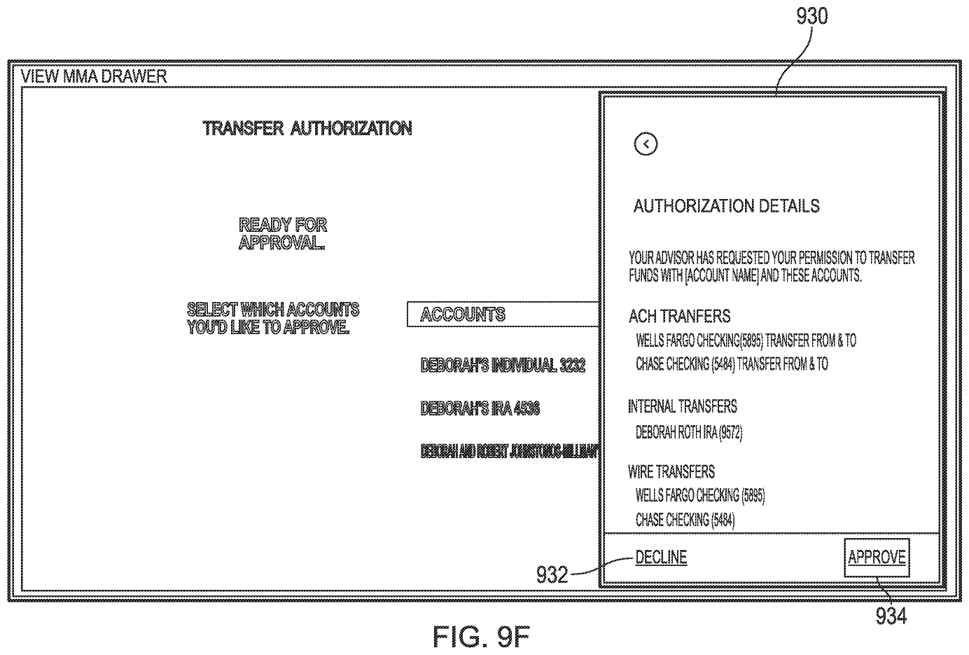

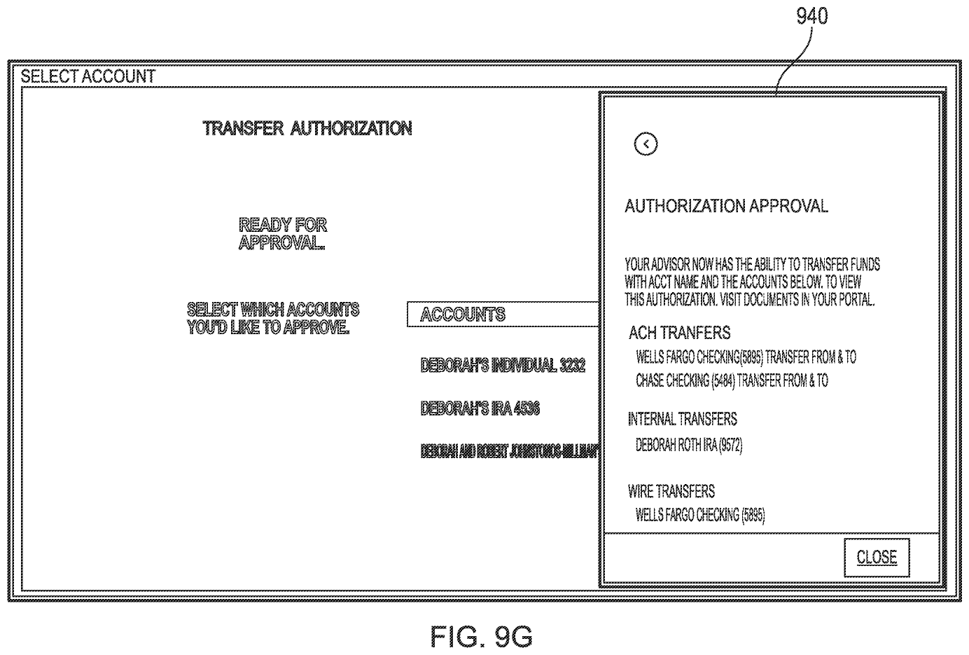

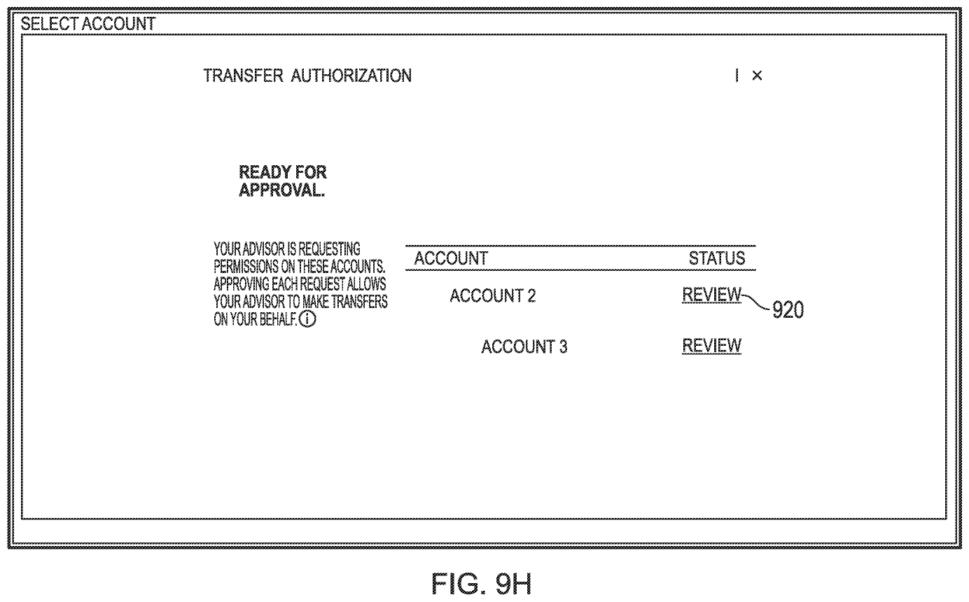

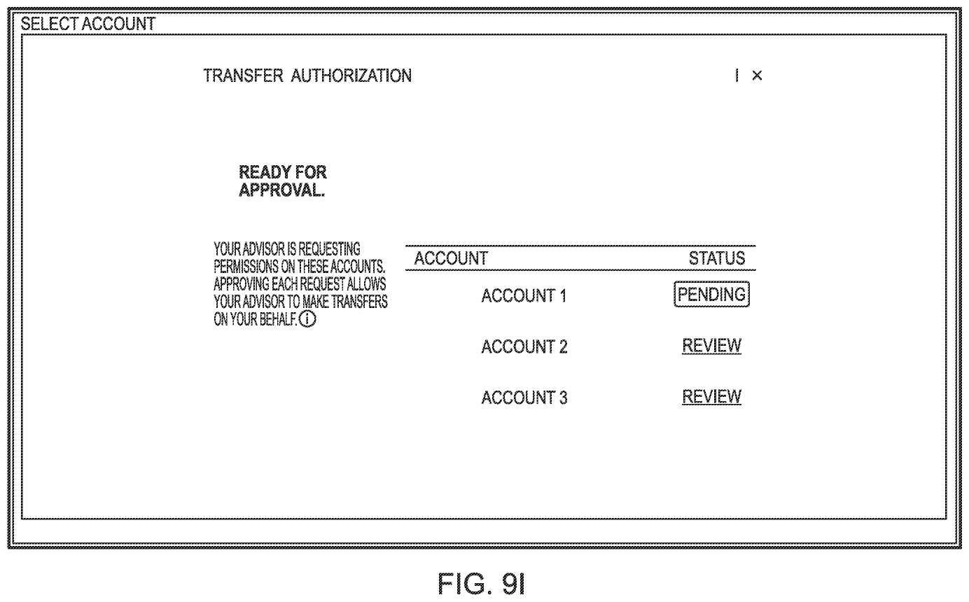

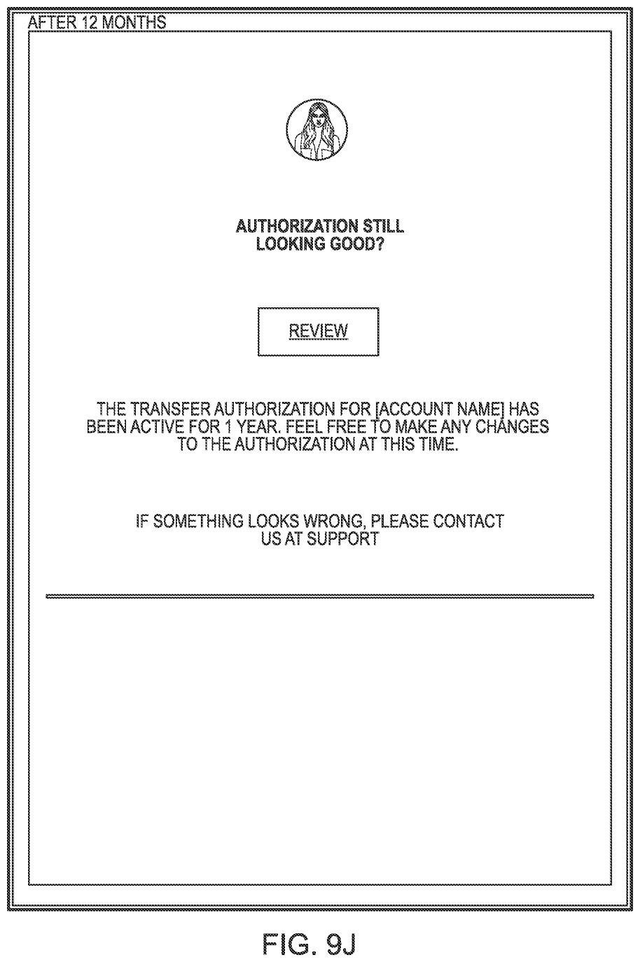

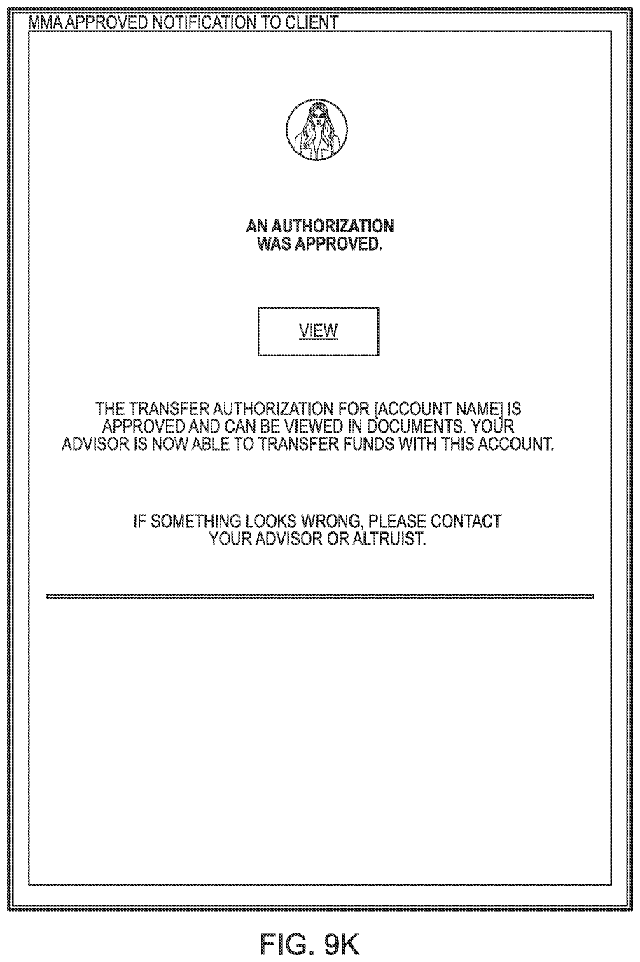

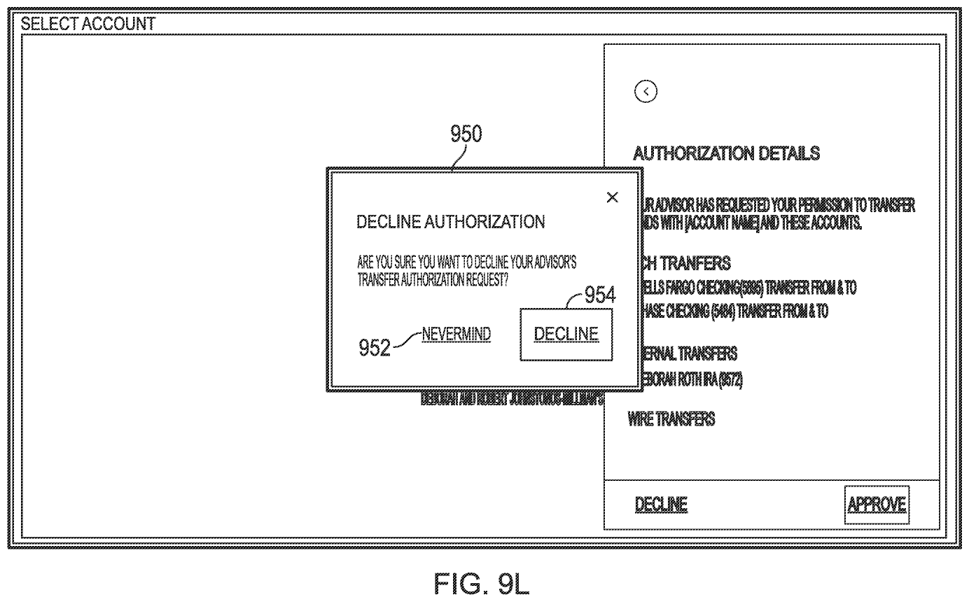

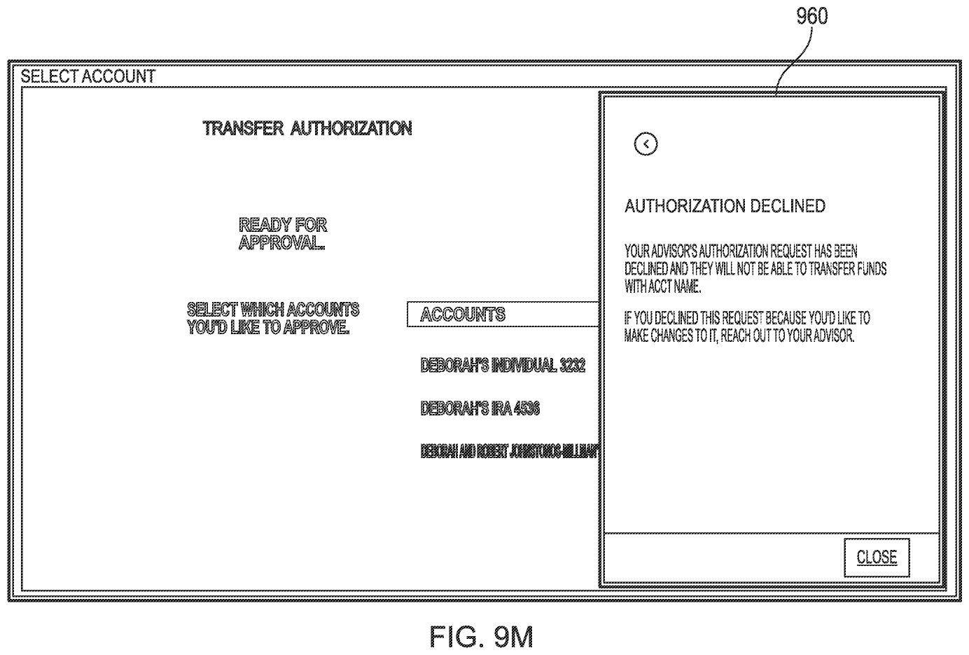

FIGS. 9A-9M depict an example sequence of a user, e.g., a client, interaction with an application to respond to a request to approve a digital LOA, according to certain embodiments. As shown in the user interface 800 of FIG. 9A, the user is presented with a screen requesting the user to approve authorization. The screen includes a prompt 902 that allows the user to review the authorization.

Assuming the user selects the prompt 902, the user may access a client portal associated with the application (e.g., provided by the platform 150) (e.g., as shown in FIG. 9B). As shown in FIG. 9B, the user is presented with a dashboard screen that includes an indication of the request from the advisor to review and authorize the pending authorization. The user may select the prompt 904 to review the authorization.

In certain embodiments, the advisor may cancel the authorization request before the client has reviewed and/or approved the authorization. In these embodiments, the user may be presented with a screen indicating that the authorization request has been canceled (e.g., as shown in FIG. 9C). Similarly, in cases where multiple users have to approve an authorization, one of the other users may decline the authorization before the client has reviewed and/or approved the authorization. In these cases, the user may be presented with a screen indicating that the authorization has been declined (e.g., as shown in FIG. 9D).

After the user selects the prompt 904 of the dashboard screen (shown in FIG. 9B), the user may be presented with a review screen that indicates a set of accounts with pending authorizations. As shown in FIG. 9E, for example, the user is presented with a review screen that indicates that three Accounts 1-3 have authorizations available for review. The user can select the prompt 920 to review each authorization.

Assuming the user selects the prompt 920 for a given account, the user may be presented with a window 930 that provides the authorization details for the account. As shown in FIG. 9F, for example, the window 930 may indicate the types of transfers requested (e.g., ACH Transfers, Internal Transfers, Wire Transfers), bank accounts/brokerage accounts associated with the type of transfer, and/or the type of transfer for the bank accounts. The window 930 may include a prompt 932 that allows the user to decline the authorization and a prompt 934 that allows the user to approve the authorization.

Assuming the user selects the prompt 934, the user may be presented with a window 940 indicating that the authorization is approved (e.g., as shown in FIG. 9G). The user may then be returned to the review screen, which may list the remaining accounts (e.g., Accounts 2-3) with authorizations available for review (e.g., as shown in FIG. 9H). In certain embodiments, the review screen may still list an account that the current user has approved an authorization in situations where there are other users that have to also approve the authorization. For example, as shown in FIG. 9I, the review screen lists Account 1 with a “pending” status, indicating that other users have to approve the authorization before it can be removed from the review screen. When all other users have approved the authorization, the user may receive a message indicating that the authorization was approved (e.g., as shown in FIG. 9K).

In certain embodiments, the user may receive a message requesting the user to re-approve the authorization. The message may be received a predetermined amount of time after a prior approval (e.g., 12 months, 24 months, or some other time frame). As shown in FIG. 9J, for example, the user is presented with a request to review the authorization for an account after 12 months has elapsed since the prior approval.

Assuming the user selects prompt 932 (e.g., to decline an authorization), the user may be presented with a window 950 requesting the user to confirm declining the authorization. As shown in FIG. 9L, the window 950 includes a prompt 952 that allows the user to cancel declining the authorization and a prompt 954 that allows the user to proceed with declining the authorization. Assuming the user selects prompt 954, the user is presented with a window 960 confirming that the authorization has been declined (e.g., as shown in FIG. 9M).

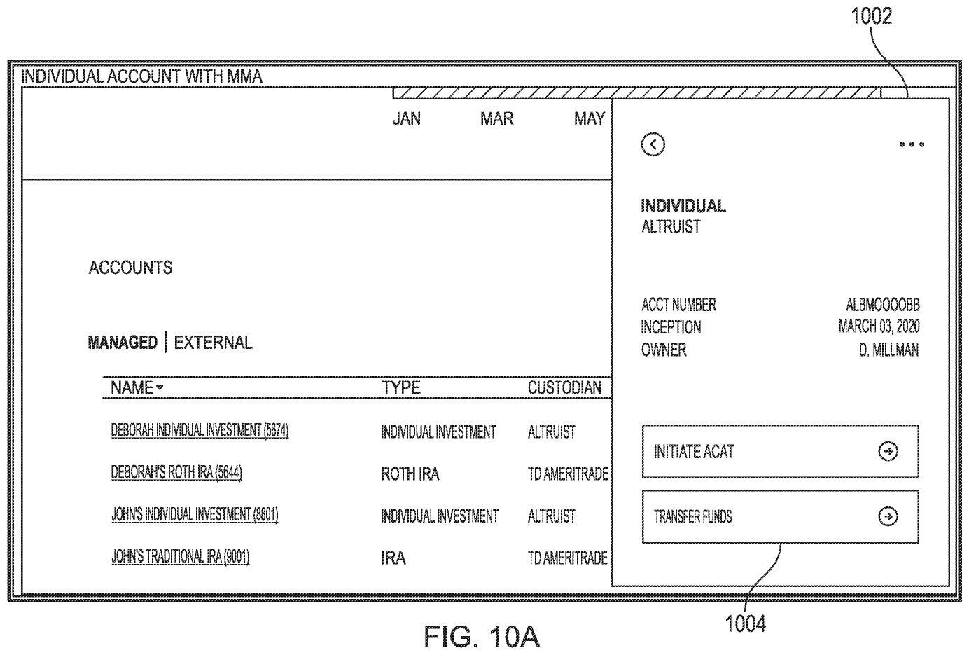

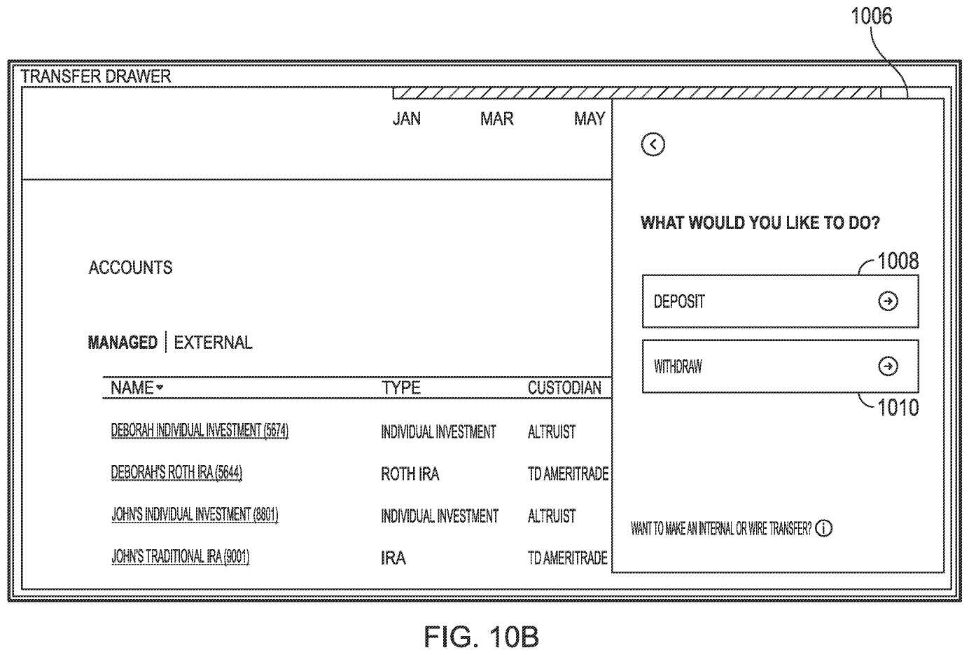

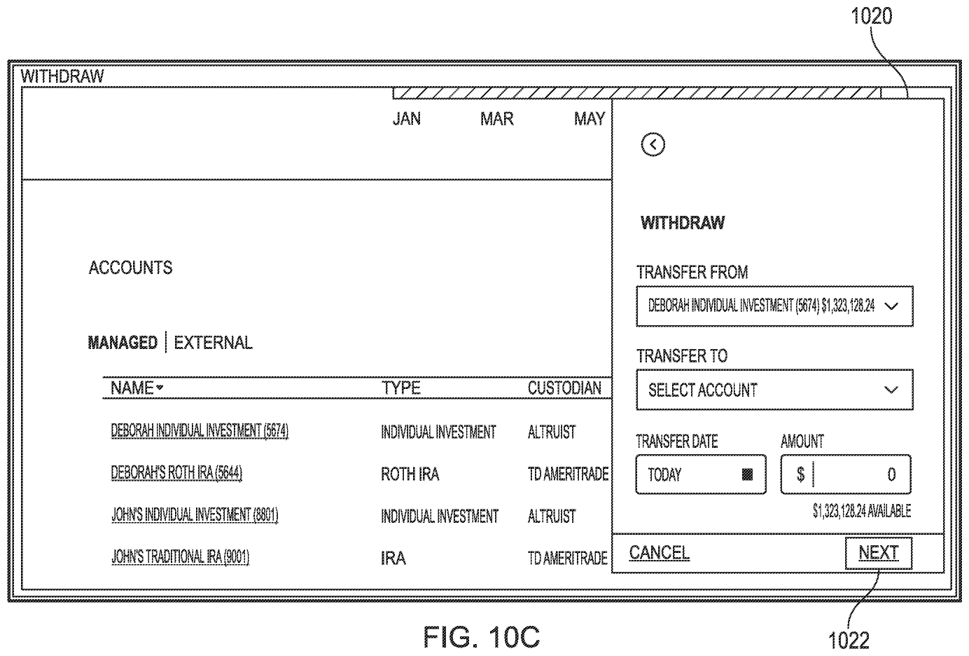

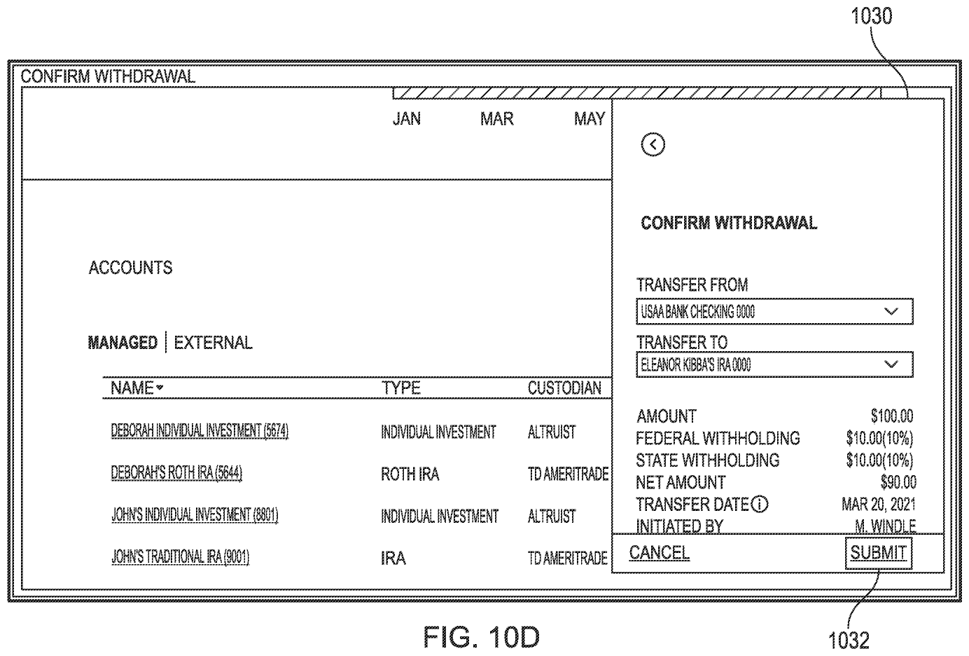

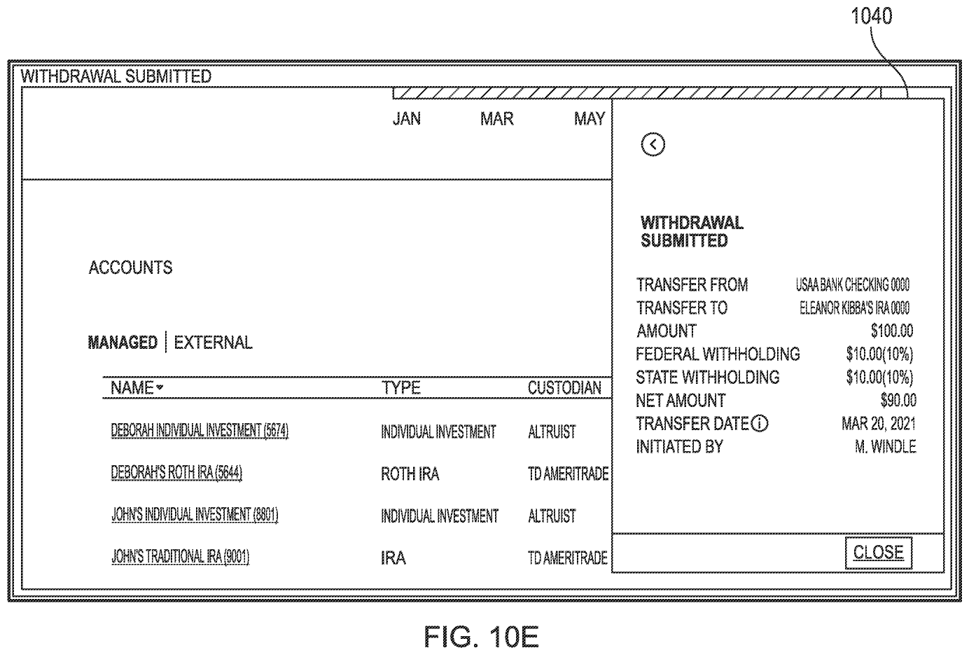

FIGS. 10A-10E depict an example sequence of a user interaction with an application to initiate an account transfer, according to certain embodiments. As shown in FIG. 10A, a user (e.g., advisor) may access a client's account within the application. The user may be presented with a window 1002 with a prompt 1004 allowing the user to initiate a transfer of funds. Assuming the user selects the prompt 1004, the user may be presented with a window 1006 with prompts 1008 and 1010. The prompt 1008 allows the user to initiate a deposit (e.g., transferring funds into the brokerage account). The prompt 1010 allows the user to initiate a withdrawal (e.g., transferring funds out of the brokerage account).

As shown in FIG. 10C, assuming the user selects prompt 1010, the user may be presented with a window 1020 to allow the user to input information for the withdrawal. Here, for example, the window 1020 includes fields for “Transfer from,” “Transfer to,” “Transfer date,” and “Amount.” After the user selects the prompt 1022, the user can be presented with a window 1030 that allows the user to view the withdrawal information and confirm the withdrawal (e.g., as shown in FIG. 10D). Once the user selects the prompt 1032, the user is presented with a window 1040 confirming that the withdrawal has been submitted (e.g., as shown in FIG. 10E).

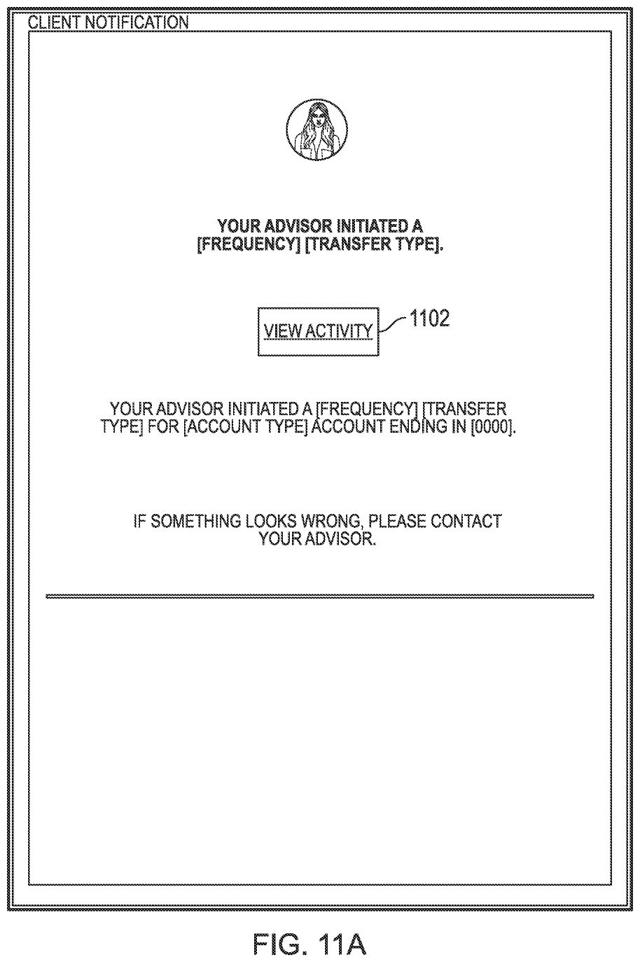

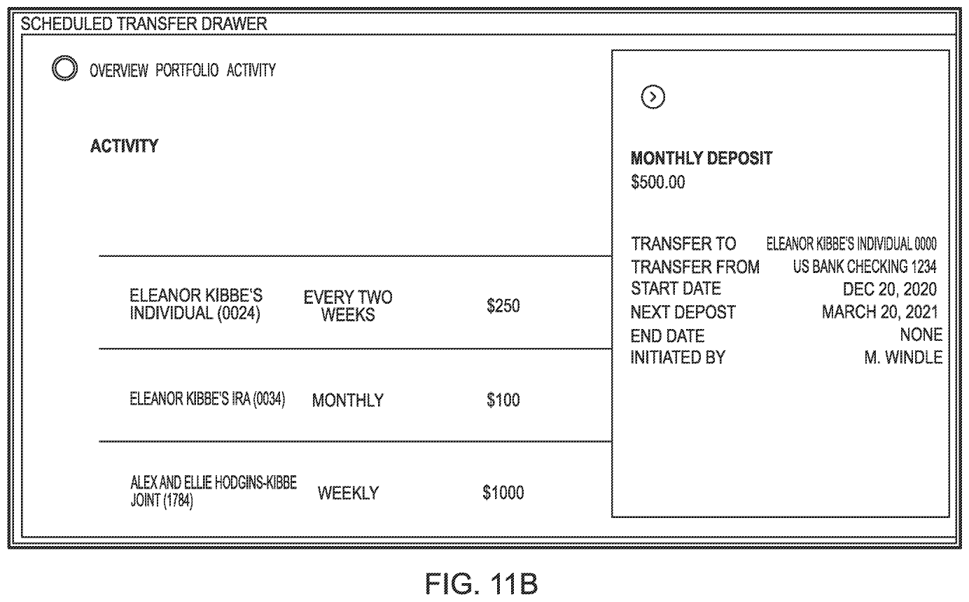

FIGS. 11A-11B depict an example sequence of a user interaction with an application to view an account transfer, according to certain embodiments. As shown in FIG. 11A, the user may receive an indication (or message) when the advisor initiates an account transfer on behalf of the user. The indication may include a prompt 1102 that allows the user to view the account activity. Assuming the user selects the prompt 1102, the user may be able to access the scheduled transfer activity screen associated with their account (e.g., as shown in FIG. 11B) in order to view details of the initiated account transfer.

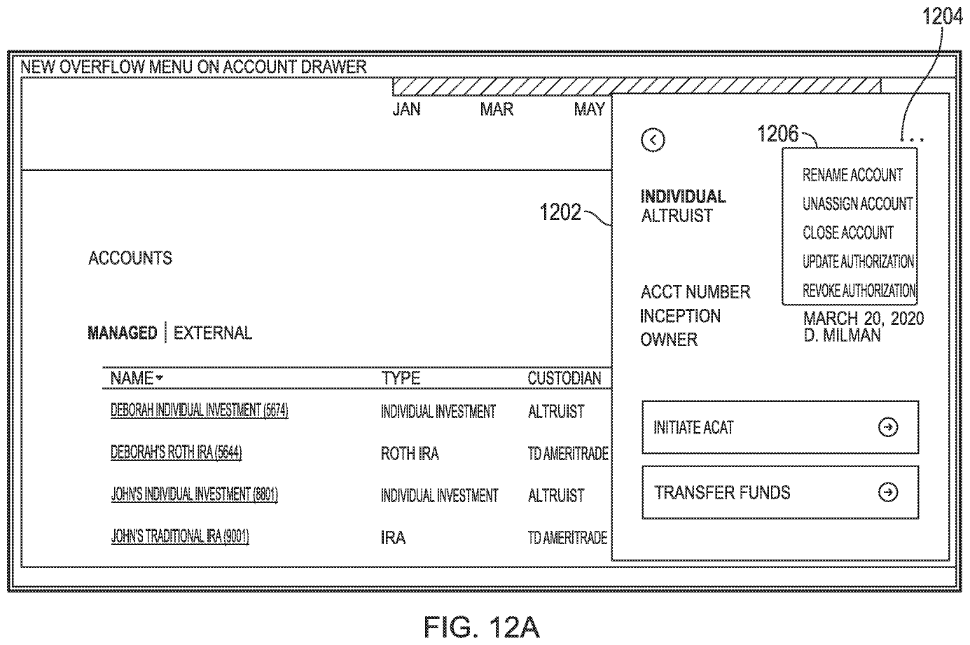

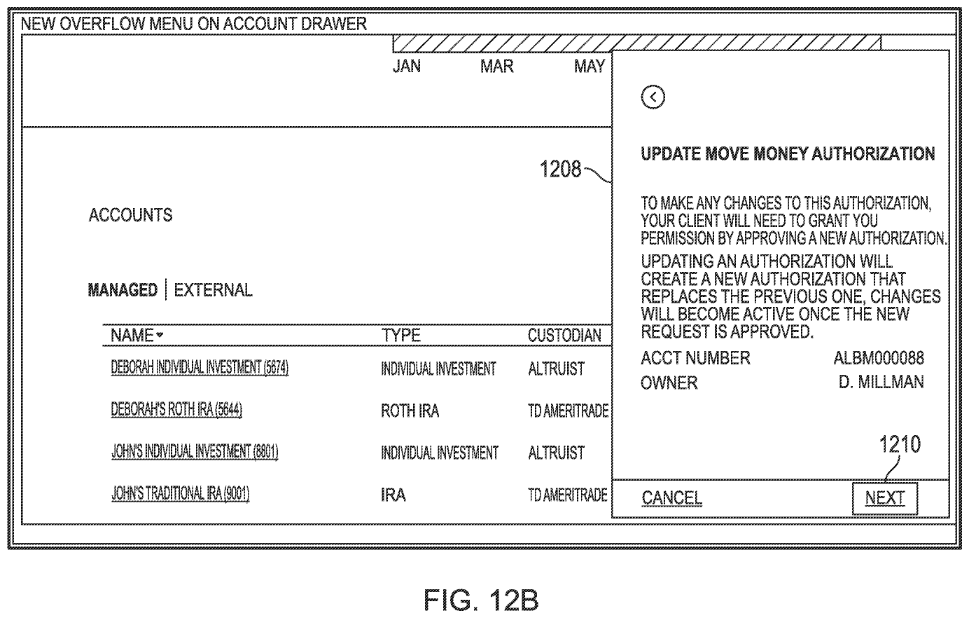

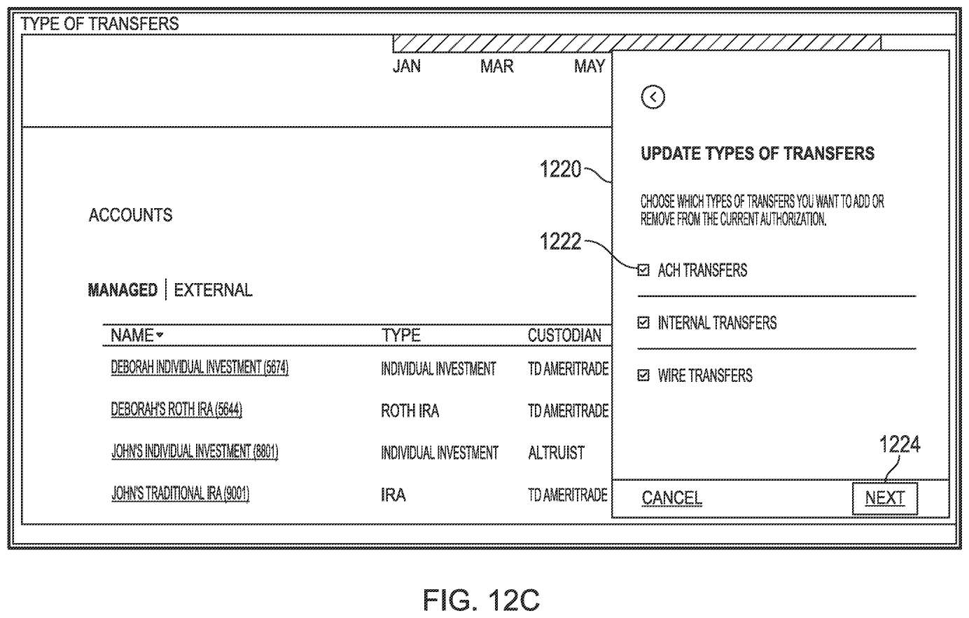

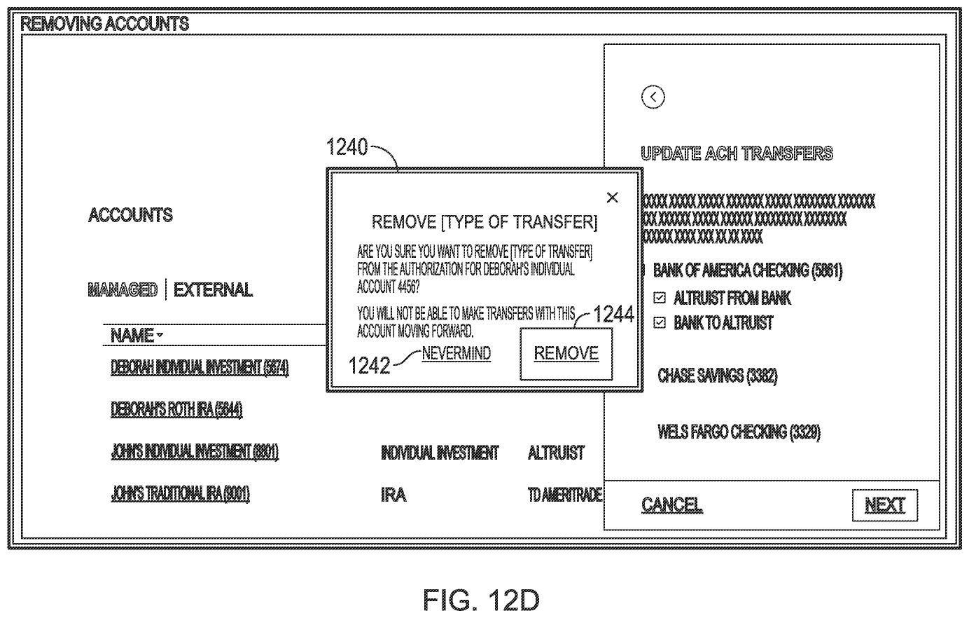

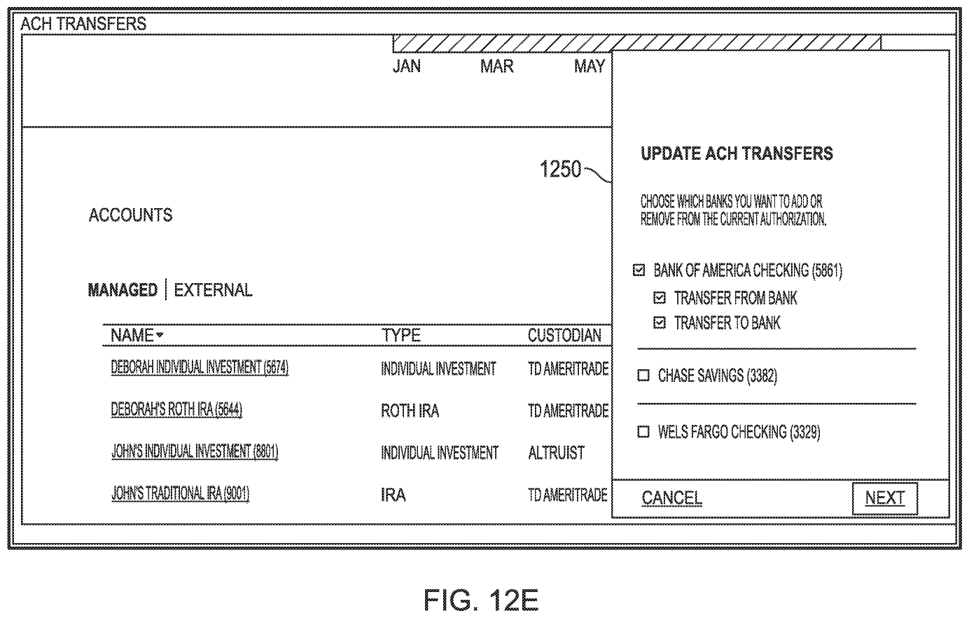

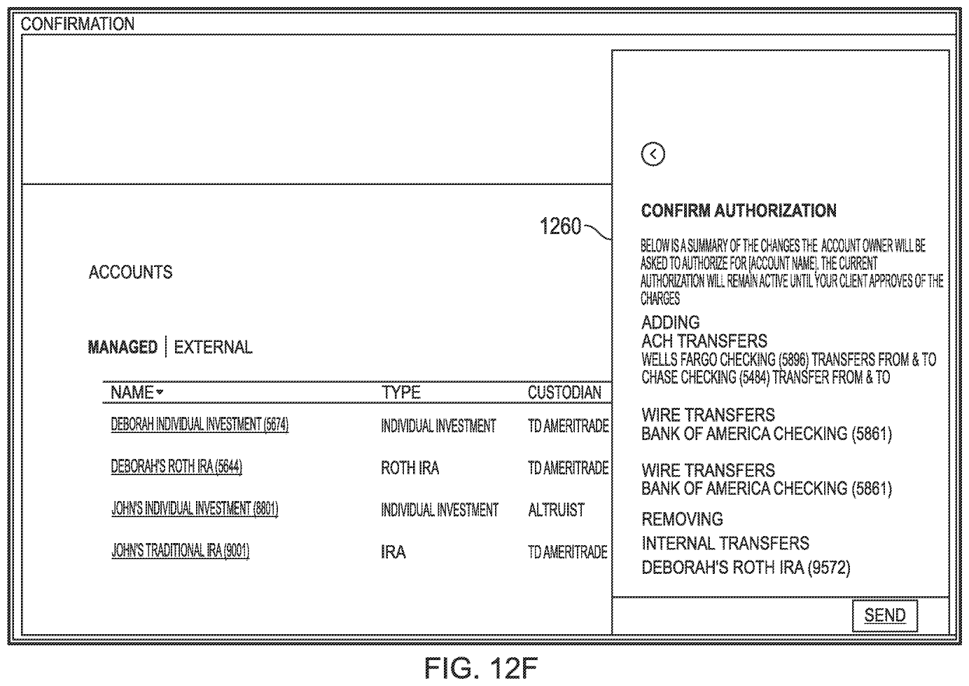

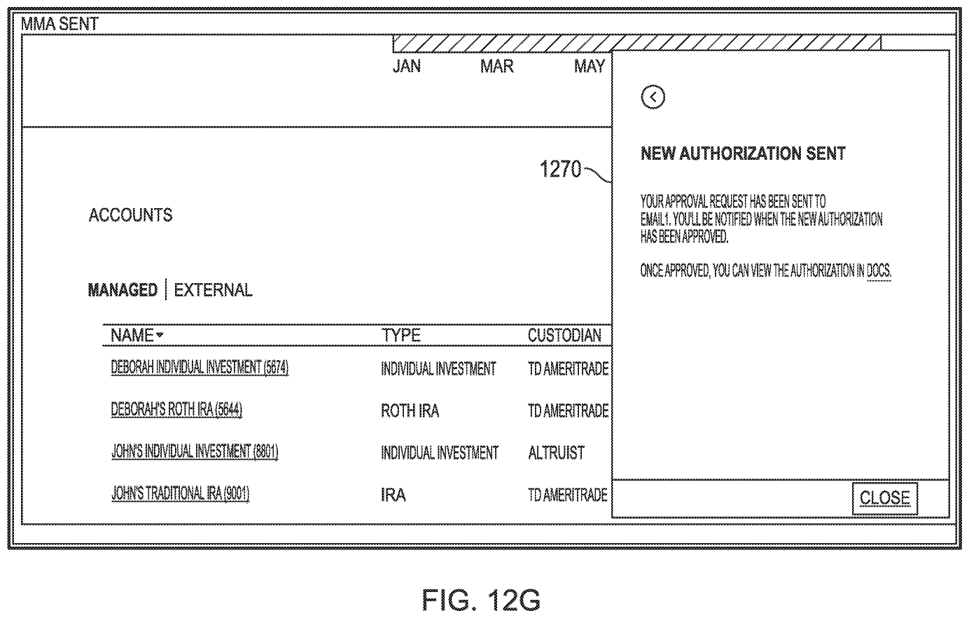

FIGS. 12A-12G depict an example sequence of a user interaction with an application to modify a digital LOA, according to certain embodiments. As shown in FIG. 12A, the user is presented with an initial screen that includes a window 1202 with information pertaining to an individual account (e.g., account number, inception date, etc.). The window includes a prompt 1204 that allows a user to view an overflow menu 1206 with additional features. In FIG. 12A, for example, the overflow menu 1206 includes a field for “Update Authorization” and a field for “Revoke Authorization.”

Assuming the user selects the field for “Update Authorization,” the user may be presented with a window 1208 that presents information regarding the workflow for initiating the update of the authorization (e.g., as shown in FIG. 12B). Assuming the user selects the prompt 1210, the user may be presented with a window 1220 which allows the user to select the types of transfers to modify (e.g., add or remove) within the current authorization. As shown in FIG. 12C, the window includes a prompt 1222 for each type of transfer that allows the user to select/deselect the respective type of transfer.

In certain embodiments, the user may be presented with a message asking the user to confirm a modification. For example, as shown in FIG. 12D, the user is presented with a window 1240 asking the user to confirm the removal of a type of transfer from the existing authorization. The window 1240 includes a prompt 1242 that allows the user to cancel the modification and a prompt 1244 that allows the user to proceed with the modification.

As shown in FIG. 12E, the user is presented with a window 1250 that allows the user to choose which bank accounts to modify (e.g., add or remove) from the current authorization. The window 1250 includes prompts that allow the user to select/deselect each bank account (along with the type of transfer for the bank account). As shown in FIG. 12F, the user is presented with a window 1260 that allows the user to view a summary of the modifications and confirm the authorization. As shown in FIG. 12G, once the user confirms the modifications, the user is presented with a window 1270 indicating that the approval requests for the new authorization have been sent.

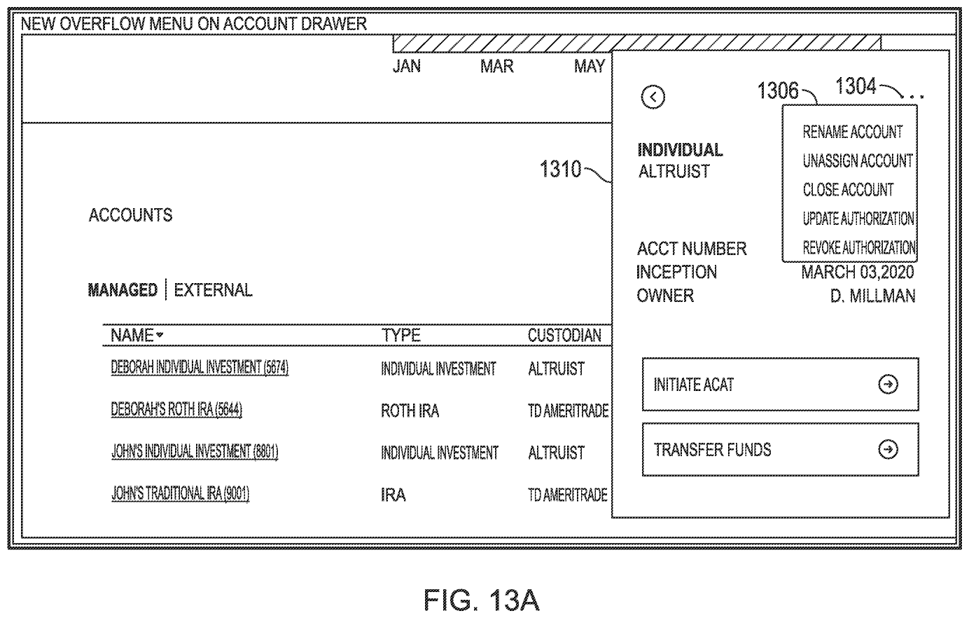

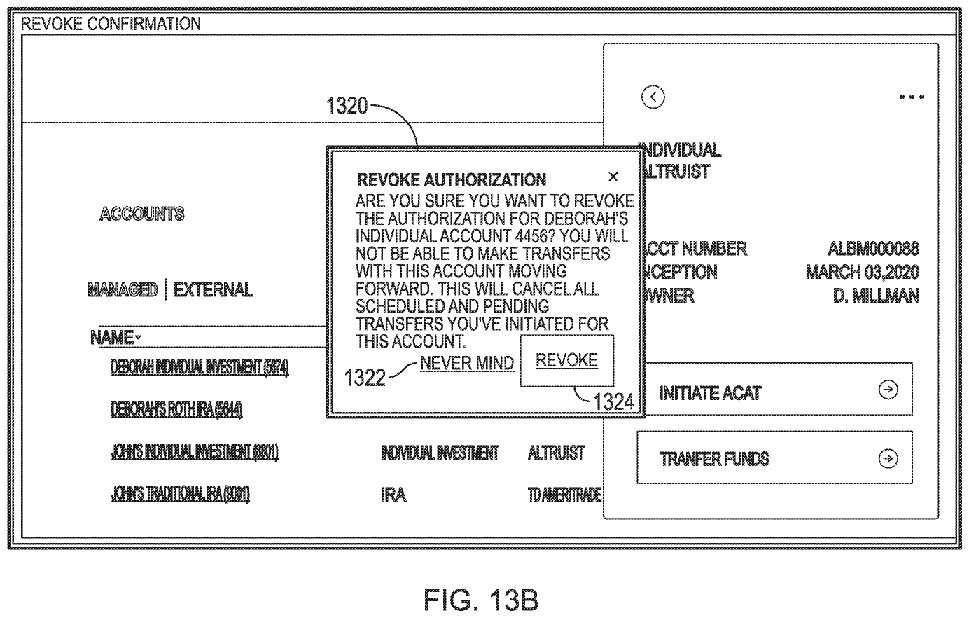

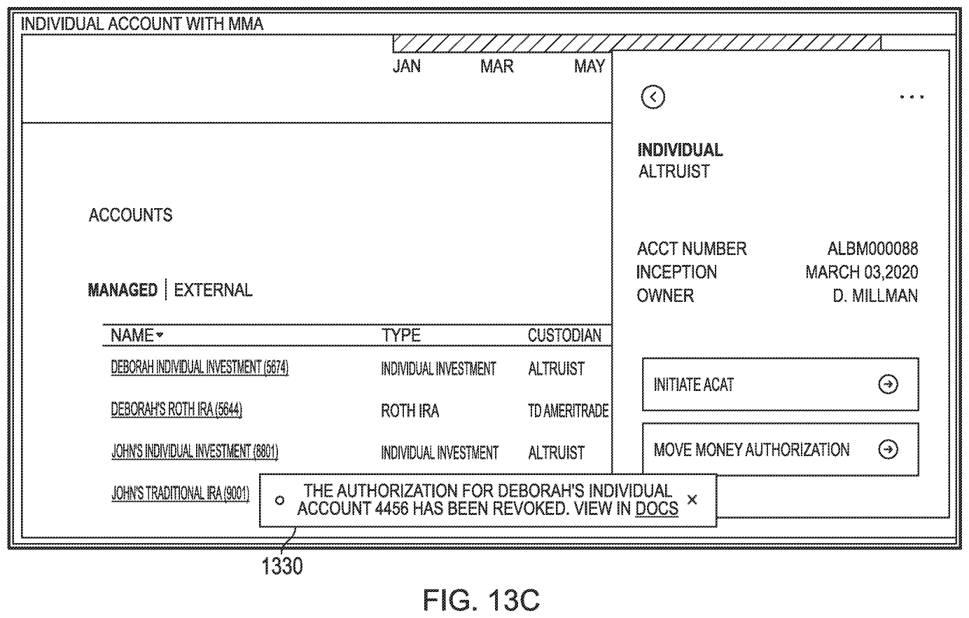

FIGS. 13A-13C depict an example sequence of a user interaction with an application to revoke a digital LOA, according to certain embodiments. As shown in FIG. 13A, the user is presented with an initial screen that includes a window 1310 with information pertaining to an individual account (e.g., account number, inception date, etc.). The window includes a prompt 1304 that allows a user to view an overflow menu 1306 with additional features. In FIG. 13A, for example, the overflow menu 1306 includes a field for “Revoke Authorization.”

Assuming the user selects the field for “Revoke Authorization,” the user may be presented with a window 1320 that includes a prompt 1322 that allows the user to cancel the revocation and a prompt 1324 that allows the user to proceed with the revocation. Assuming the user selects the prompt 1324, the user may be presented with the initial screen with a window 1330 indicating that the authorization has been revoked.

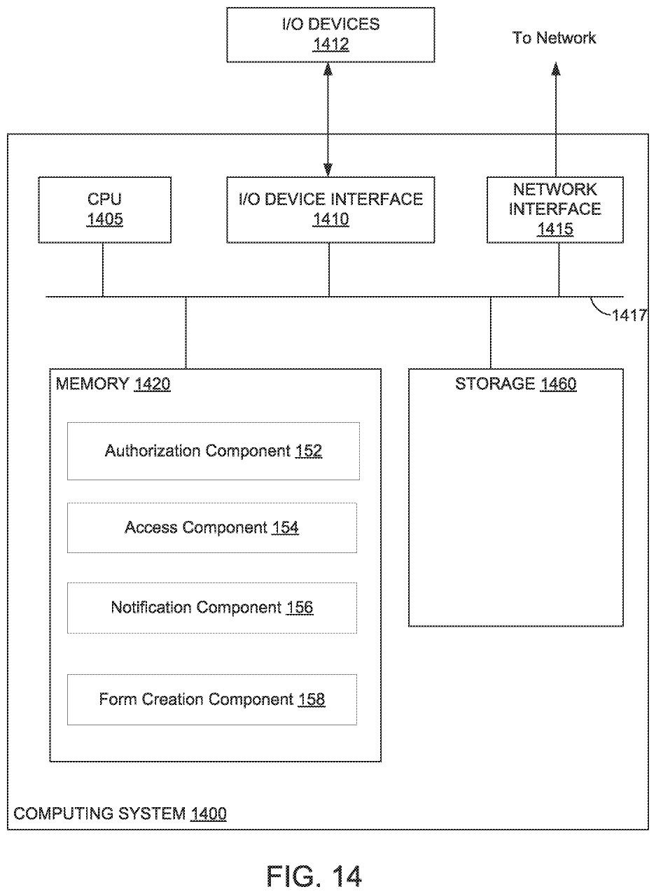

FIG. 14 illustrates an example computing system 1400 configured to perform ophthalmic image registration, according to certain embodiments. As shown, the computing system 1400 includes, without limitation, a central processing unit (CPU) 1405, a network interface 1415, a memory 1420, and storage 1460, each connected to a bus 1417. The computing system 1400 may also include an I/O device interface 1410 connecting I/O devices 1412 (e.g., keyboard, display and mouse devices) to the computing system 1400. The computing system 1400 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used.

The CPU 1405 retrieves and executes programming instructions stored in the memory 1420 as well as stored in the storage 1460. The bus 1417 is used to transmit programming instructions and application data between the CPU 1405, I/O device interface 1410, storage 1460, network interface 1415, and memory 1420. Note, CPU 1405 is included to be representative of a single CPU, multiple CPUs, a single CPU having multiple processing cores, and the like, and the memory 1420 is generally included to be representative of a random access memory. The storage 1460 may be a disk drive or flash storage device. Although shown as a single unit, the storage 1460 may be a combination of fixed and/or removable storage devices, such as fixed disc drives, removable memory cards, optical storage, network attached storage (NAS), or a storage area-network (SAN). Illustratively, the memory 1420 includes the authorization component 152, access component 154, notification component 156, and form creation component 158, which are discussed in greater detail above.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

The foregoing description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.” The word “exemplary” is used herein to mean “serving as an example, instance, or illustration.” Any aspect described herein as “exemplary” is not necessarily to be construed as preferred or advantageous over other aspects.

What is claimed is:

1. A system comprising:
one or more processors; and
a memory comprising instructions, which when executed by the one or more processors, cause the system to perform an operation, the operation comprising:
detecting, on a page of an application, a first request to create a transfer authorization for a first client account;
in response to the first request, presenting, on the page of the application, an indication of a type of transfer option associated with the first client account;
upon determining that a first selection state of the type of transfer option indicates the type of transfer option is selected, determining a set of second client accounts that are linked to the first client account within the application and that support the type of transfer option;
determining, for each of the set of second client accounts, a second selection state of the second client account indicating whether the second client account is selected;
automatically generating an electronic transfer authorization form, based on the second selection state of each of the set of second client accounts, wherein automatically generating the electronic transfer authorization form comprises auto-populating the electronic transfer authorization form with information authorizing transfers between the first client account and the selected set of second client accounts; and
transmitting a second request to one or more users associated with the selected set of second client accounts to approve the electronic transfer authorization form.

2. The system of claim 1, wherein upon receiving, in response to the second request, an indication from at least one of the one or more users that the electronic transfer authorization form is declined, canceling the first request and transmitting an indication that the first request is canceled.

3. The system of claim 1, wherein upon receiving, in response to the second request, an indication from each of the one or more users that the electronic transfer authorization form is approved, updating a type of access of an advisor to the selected set of second client accounts, based on the electronic transfer authorization form.

4. The system of claim 1, the operation further comprising presenting an indication on the page of the application of a status of the first request.

5. The system of claim 1, the operation further comprising, in response to the first request:
presenting a plurality of transfer directions associated with the type of transfer option; and
determining a third selection state of each transfer direction indicating whether the transfer direction is selected.

6. The system of claim 5, wherein the electronic transfer authorization form also includes information authorizing transfers between the first client account and the selected set of second client accounts using the selected transfer directions.

7. The system of claim 1, the operation further comprising upon receiving an indication that another electronic transfer authorization form has been approved by the one or more users, replacing the electronic transfer authorization form with the other electronic transfer authorization form.

8. The system of claim 1, wherein the other electronic transfer authorization form comprises information authorizing transfers between the first client account and a different selected set of second client accounts.

9. The system of claim 1, the operation further comprising upon receiving an indication that the electronic transfer authorization form has been revoked, updating a type of access of an advisor to the selected set of second client accounts based on the revoked electronic transfer authorization form.

10. A computer-readable storage medium storing instructions, which, when executed on one or more computing systems, perform an operation comprising:
detecting, on a page of an application, a first request to create a transfer authorization for a first client account;
in response to the first request, presenting, on the page of the application, an indication of a type of transfer option associated with the first client account;
upon determining that a first selection state of the type of transfer option indicates the type of transfer option is selected, determining a set of second client accounts that are linked to the first client account within the application and that support the type of transfer option;
determining, for each of the set of second client accounts, a second selection state of the second client account indicating whether the second client account is selected;
automatically generating an electronic transfer authorization form, based on the second selection state of each of the set of second client accounts, wherein automatically generating the electronic transfer authorization form comprises auto-populating the electronic transfer authorization form with information authorizing transfers between the first client account and the selected set of second client accounts; and
transmitting a second request to one or more users associated with the selected set of second client accounts to approve the electronic transfer authorization form.

11. The computer-readable storage medium of claim 10, wherein upon receiving, in response to the second request, an indication from at least one of the one or more users that the electronic transfer authorization form is declined, canceling the first request and transmitting an indication that the first request is canceled.

12. The computer-readable storage medium of claim 10, wherein upon receiving, in response to the second request, an indication from each of the one or more users that the electronic transfer authorization form is approved, updating a type of access of an advisor to the selected set of second client accounts, based on the electronic transfer authorization form.

13. The computer-readable storage medium of claim 10, the operation further comprising presenting an indication on the page of the application of a status of the first request.

14. The computer-readable storage medium of claim 10, the operation further comprising, in response to the first request:
presenting a plurality of transfer directions associated with the type of transfer option; and
determining a third selection state of each transfer direction indicating whether the transfer direction is selected.

15. The computer-readable storage medium of claim 14, wherein the electronic transfer authorization form also includes information authorizing transfers between the first client account and the selected set of second client accounts using the selected transfer directions.

16. The computer-readable storage medium of claim 10, the operation further comprising upon receiving an indication that another electronic transfer authorization form has been approved by the one or more users, replacing the electronic transfer authorization form with the other electronic transfer authorization form.

17. The computer-readable storage medium of claim 10, wherein the other electronic transfer authorization form comprises information authorizing transfers between the first client account and a different selected set of second client accounts.

18. The computer-readable storage medium of claim 10, the operation further comprising upon receiving an indication that the electronic transfer authorization form has been revoked, updating a type of access of an advisor to the selected set of second client accounts based on the revoked electronic transfer authorization form.

19. A computer-implemented method comprising:
detecting, on a page of an application, a first request to create a transfer authorization for a first client account;
in response to the first request, presenting, on the page of the application, an indication of a type of transfer option associated with the first client account;
upon determining that a first selection state of the type of transfer option indicates the type of transfer option is selected, determining a set of second client accounts that are linked to the first client account within the application and that support the type of transfer option;
determining, for each of the set of second client accounts, a second selection state of the second client account indicating whether the second client account is selected;
automatically generating an electronic transfer authorization form, based on the second selection state of each of the set of second client accounts, wherein automatically generating the electronic transfer authorization form comprises auto-populating the electronic transfer authorization form with information authorizing transfers between the first client account and the selected set of second client accounts; and
transmitting a second request to one or more users associated with the selected set of second client accounts to approve the electronic transfer authorization form.

20. The computer-implemented method of claim 19, wherein upon receiving, in response to the second request, an indication from each of the one or more users that the electronic transfer authorization form is approved, updating a type of access of an advisor to the selected set of second client accounts, based on the electronic transfer authorization form.
